(19) United States
(12) Patent Application Publication
(10) Pub. No.: US 2024/0008093 A1
(43) Pub. Date: Jan. 4, 2024

(54) FREQUENCY HOPPING CONSIDERATIONS FOR PHYSICAL UPLINK SHARED CHANNEL REPETITIONS

(71) Applicant: QUALCOMM Incorporated, San Diego, CA (US)

(72) Inventors: Hung Dinh LY, San Diego, CA (US); Kexin XIAO, Shanghai (CN); Krishna Kiran MUKKAVILLI, San Diego, CA (US)

(21) Appl. No.: 18/254,145

(22) PCT Filed: Jan. 15, 2021
(86) PCT No.: PCT/CN2021/072257

§ 371 Date: May 23, 2023

(51) Int. Cl. H04W 74/08

(52) U.S. Cl. CPC H04W 74/0833; H04L 1/08

(57) ABSTRACT

Methods, systems, and devices for wireless communications are described. A user equipment (UE) may transmit a random access channel preamble to abase station. The UE may receive, from the base station and in response to the random access channel preamble, a grant comprising a first frequency hopping indication associated with intra-slot frequency hopping and a second frequency hopping indication associated with inter-slot frequency hopping. The UE may identify, based at least in part on the first frequency hopping indication or the second frequency hopping indication, a frequency hopping configuration for transmission of repetitions of an uplink transmission responsive to the grant. The UE may transmit the repetitions of the uplink transmission using one or more frequency Chops in accordance with the frequency hopping configuration.

### CROSS REFERENCE

The present Application is a 371 national stage filing of International PCT Application No. PCT/CN2021/072257 by LY et al. entitled “FREQUENCY HOPPING CONSIDERATIONS FOR PHYSICAL UPLINK SHARED CHANNEL REPETITIONS,” filed Jan. 15, 2021, which is assigned to the assignee hereof, and which is expressly incorporated by reference in its entirety herein.

### FIELD OF TECHNOLOGY

The following relates to wireless communications, including frequency hopping considerations for physical uplink shared channel repetitions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support frequency hopping considerations for physical uplink shared channel (PUSCH) repetitions. Generally, the described techniques provide for improved frequency hopping for PUSCH message three (Msg3) repetitions in a four-step random access procedure. For example, a user equipment (UE) may transmit a random access channel (RACH) preamble to a base station, and may receive a grant for RACH Msg3 transmission with repetitions. The grant may be a RACH message two (Msg2) grant (e.g., a random access response (RAR)) and/or may be a downlink control information (DCI) grant (e.g., DCI format 1_0 or 0_0). The grant may carry or otherwise indicate inter-slot frequency hopping flags and inter-slot frequency hopping flags (e.g., indications). Generally, each frequency hopping flag may include one or more bits (e.g., repurposed bits and/or reserved bits) indicating whether intra-slot and/or inter-slot frequency hopping is configured for the RACH Msg3 repetitions. The UE may identify the frequency hopping configuration(s) for the RACH Msg3 repetition transmissions according to one or both flags indicated in the grant and transmit repetitions of the RACH Msg3 according to the frequency hopping configuration. For example, the UE may transmit initial and/or retransmission repetitions of the RACH Msg3 according to the inter-slot and/or intra-slot frequency hopping.

A method for wireless communication at a UE is described. The method may include transmitting a RACH preamble to a base station, receiving, from the base station and in response to the RACH preamble, a grant including a first frequency hopping indication associated with intra-slot frequency hopping and a second frequency hopping indication associated with inter-slot frequency hopping, identifying, based on the first frequency hopping indication or the second frequency hopping indication, a frequency hopping configuration for transmission of repetitions of an uplink transmission responsive to the grant, and transmitting the repetitions of the uplink transmission using one or more frequency hops in accordance with the frequency hopping configuration.

An apparatus for wireless communication at a UE is described. The apparatus may include a processor, memory in electronic communication with the processor, and instructions stored in the memory. The instructions may be executable by the processor to cause the apparatus to transmit a RACH preamble to a base station, receive, from the base station and in response to the RACH preamble, a grant including a first frequency hopping indication associated with intra-slot frequency hopping and a second frequency hopping indication associated with inter-slot frequency hopping, identify, based on the first frequency hopping indication or the second frequency hopping indication, a frequency hopping configuration for transmission of repetitions of an uplink transmission responsive to the grant, and transmit the repetitions of the uplink transmission using one or more frequency hops in accordance with the frequency hopping configuration.

Another apparatus for wireless communication at a UE is described. The apparatus may include means for transmitting a RACH preamble to a base station, means for receiving, from the base station and in response to the RACH preamble, a grant including a first frequency hopping indication associated with intra-slot frequency hopping and a second frequency hopping indication associated with inter-slot frequency hopping, means for identifying, based on the first frequency hopping indication or the second frequency hopping indication, a frequency hopping configuration for transmission of repetitions of an uplink transmission responsive to the grant, and means for transmitting the repetitions of the uplink transmission using one or more frequency hops in accordance with the frequency hopping configuration.

A non-transitory computer-readable medium storing code for wireless communication at a UE is described. The code may include instructions executable by a processor to transmit a RACH preamble to a base station, receive, from the base station and in response to the RACH preamble, a grant including a first frequency hopping indication associated with intra-slot frequency hopping and a second frequency hopping indication associated with inter-slot frequency hopping, identify, based on the first frequency hopping indication or the second frequency hopping indication, a frequency hopping configuration for transmission of repetitions of an uplink transmission responsive to the grant, and transmit the repetitions of the uplink transmission using one or more frequency hops in accordance with the frequency hopping configuration.

Some examples of the method, apparatuses, and non-transitory computer-readable medium described herein may further include operations, features, means, or instructions for determining that the first frequency hopping indication associated with intra-slot frequency hopping may be configured in the grant and transmitting each repetition of the uplink transmission according to the frequency hopping configuration using a same starting resource block and a same frequency offset within a slot.

Some examples of the method, apparatuses, and non-transitory computer-readable medium described herein may further include operations, features, means, or instructions for determining that the first frequency hopping indication associated with intra-slot frequency hopping may be configured in the grant and transmitting each repetition of the uplink transmission according to the frequency hopping configuration using a same starting resource block and a different frequency offset within a slot.

In some examples of the method, apparatuses, and non-transitory computer-readable medium described herein, receiving the grant may include operations, features, means, or instructions for receiving a RAR message.

In some examples of the method, apparatuses, and non-transitory computer-readable medium described herein, receiving the grant may include operations, features, means, or instructions for receiving a DCI message that includes a CRC scrambled by either a random access radio network temporary identifier or a temporary cell random access radio network temporary identifier, where the second frequency hopping indication may be included within reserved bits of the DCI message.

In some examples of the method, apparatuses, and non-transitory computer-readable medium described herein, the reserved bits include bits reserved for at least one of a hybrid automatic repeat request (HARD) process number or a new data indicator (NDI).

In some examples of the method, apparatuses, and non-transitory computer-readable medium described herein, either the first frequency hopping indication or the second frequency hopping indication may be configured for the uplink transmission by the grant.

Some examples of the method, apparatuses, and non-transitory computer-readable medium described herein may further include operations, features, means, or instructions for transmitting each repetition of an initial transmission, a first retransmission, or both, of the uplink transmission based on the first frequency hopping indication associated with intra-slot frequency hopping and transmitting each repetition of a second retransmission of the uplink transmission based on the second frequency hopping indication associated with inter-slot frequency hopping.

Some examples of the method, apparatuses, and non-transitory computer-readable medium described herein may further include operations, features, means, or instructions for transmitting each repetition of an initial transmission, a first retransmission, or both, of the uplink transmission based on the second frequency hopping indication associated with inter-slot frequency hopping and transmitting each repetition of a second retransmission of the uplink transmission based on the first frequency hopping indication associated with intra-slot frequency hopping.

Some examples of the method, apparatuses, and non-transitory computer-readable medium described herein may further include operations, features, means, or instructions for determining that both the first frequency hopping indication associated with intra-slot frequency hopping and that the second frequency hopping indication associated with inter-slot frequency hopping may be configured in the grant and selecting the frequency hopping configuration based on the first frequency hopping indication.

Some examples of the method, apparatuses, and non-transitory computer-readable medium described herein may further include operations, features, means, or instructions for determining that both the first frequency hopping indication associated with intra-slot frequency hopping and that the second frequency hopping indication associated with inter-slot frequency hopping may be configured in the grant and selecting the frequency hopping configuration based on the second frequency hopping indication.

A method for wireless communication at a base station is described. The method may include receiving a RACH preamble from a UE, transmitting, to the UE and in response to the RACH preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant, and receiving the repetitions of the uplink transmission using one or more frequency hops in accordance with the frequency hopping configuration.

An apparatus for wireless communication at a base station is described. The apparatus may include a processor, memory in electronic communication with the processor, and instructions stored in the memory. The instructions may be executable by the processor to cause the apparatus to receive a RACH preamble from a UE, transmit, to the UE and in response to the RACH preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant, and receive the repetitions of the uplink transmission using one or more frequency hops in accordance with the frequency hopping configuration.

Another apparatus for wireless communication at a base station is described. The apparatus may include means for receiving a RACH preamble from a UE, means for transmitting, to the UE and in response to the RACH preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant, and means for receiving the repetitions of the uplink transmission using one or more frequency hops in accordance with the frequency hopping configuration.

A non-transitory computer-readable medium storing code for wireless communication at a base station is described. The code may include instructions executable by a processor to receive a RACH preamble from a UE, transmit, to the UE and in response to the RACH preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant, and receive the repetitions of the uplink transmission using one or more frequency hops in accordance with the frequency hopping configuration.

Some examples of the method, apparatuses, and non-transitory computer-readable medium described herein may further include operations, features, means, or instructions for receiving each repetition of the uplink transmission according to the frequency hopping configuration using a same starting resource block and a same frequency offset within a slot.

Some examples of the method, apparatuses, and non-transitory computer-readable medium described herein may further include operations, features, means, or instructions for receiving each repetition of the uplink transmission according to the frequency hopping configuration using a same starting resource block and a different frequency offset within a slot.

In some examples of the method, apparatuses, and non-transitory computer-readable medium described herein, transmitting the grant may include operations, features, means, or instructions for transmitting a RAR message.

In some examples of the method, apparatuses, and non-transitory computer-readable medium described herein, transmitting the grant may include operations, features, means, or instructions for transmitting a DCI message that includes a CRC scrambled by either a random access radio network temporary identifier or a temporary cell random access network temporary identifier, where the second frequency hopping indication may be included within reserved bits of the DCI message.

In some examples of the method, apparatuses, and non-transitory computer-readable medium described herein, the reserved bits include bits reserved for at least one of a HARQ process number or a NDI.

In some examples of the method, apparatuses, and non-transitory computer-readable medium described herein, either the first frequency hopping indication or the second frequency hopping indication may be configured for the uplink transmission by the grant.

Some examples of the method, apparatuses, and non-transitory computer-readable medium described herein may further include operations, features, means, or instructions for receiving each repetition of an initial transmission, a first retransmission, or both, of the uplink transmission based on the first frequency hopping indication associated with intra-slot frequency hopping and receiving each repetition of a second retransmission of the uplink transmission based on the second frequency hopping indication associated with inter-slot frequency hopping.

Some examples of the method, apparatuses, and non-transitory computer-readable medium described herein may further include operations, features, means, or instructions for receiving each repetition of an initial transmission, a first retransmission, or both, of the uplink transmission based on the second frequency hopping indication associated with inter-slot frequency hopping and receiving each repetition of a second retransmission of the uplink transmission based on the first frequency hopping indication associated with intra-slot frequency hopping.

### BRIEF DESCRIPTION OF THE DRAWINGS

FIG. 1 illustrates an example of a wireless communication system that supports frequency hopping considerations for message three (Msg3) physical uplink shared channel (PUSCH) repetitions in accordance with aspects of the present disclosure.

FIG. 2 illustrates an example of a wireless communication system that supports frequency hopping considerations for Msg3 PUSCH repetitions in accordance with aspects of the present disclosure.

FIG. 3 illustrates an example of a frequency hopping configuration that supports frequency hopping considerations for Msg3 PUSCH repetitions in accordance with aspects of the present disclosure.

FIG. 4 illustrates an example of a frequency hopping configuration that supports frequency hopping considerations for Msg3 PUSCH repetitions in accordance with aspects of the present disclosure.

FIG. 5 illustrates an example of a frequency hopping configuration that supports frequency hopping considerations for Msg3 PUSCH repetitions in accordance with aspects of the present disclosure.

FIG. 6 illustrates an example of a frequency hopping configuration that supports frequency hopping considerations for Msg3 PUSCH repetitions in accordance with aspects of the present disclosure.

FIG. 7 illustrates an example of a process that supports frequency hopping considerations for Msg3 PUSCH repetitions in accordance with aspects of the present disclosure.

FIG. 8 illustrates an example of a frequency hopping configuration that supports frequency hopping considerations for Msg3 PUSCH repetitions in accordance with aspects of the present disclosure.

FIGS. 9 and 10 show block diagrams of devices that support frequency hopping considerations for Msg3 PUSCH repetitions in accordance with aspects of the present disclosure.

FIG. 11 shows a block diagram of a communications manager that supports frequency hopping considerations for Msg3 PUSCH repetitions in accordance with aspects of the present disclosure.

FIG. 12 shows a diagram of a system including a device that supports frequency hopping considerations for Msg3 PUSCH repetitions in accordance with aspects of the present disclosure.

FIGS. 13 and 14 show block diagrams of devices that support frequency hopping considerations for Msg3 PUSCH repetitions in accordance with aspects of the present disclosure.

FIG. 15 shows a block diagram of a communications manager that supports frequency hopping considerations for Msg3 PUSCH repetitions in accordance with aspects of the present disclosure.

FIG. 16 shows a diagram of a system including a device that supports frequency hopping considerations for Msg3 PUSCH repetitions in accordance with aspects of the present disclosure.

FIGS. 17 through 21 show flowcharts illustrating methods that support frequency hopping considerations for Msg3 PUSCH repetitions in accordance with aspects of the present disclosure.

### DETAILED DESCRIPTION

Some wireless communication systems may use random access channel (RACH) procedures for channel access. For example, a four-step RACH procedure includes a user equipment (UE) attempting to establish a connection with a base station by transmitting a RACH preamble (e.g., a RACH message one (Msg1)) to the base station that indicates the request. The base station responds with a random access response (RAR) message (e.g., a RACH message two (Msg2)) providing timing advance, identification information, and an uplink grant for a next RACH message from the UE (e.g., a RACH message three (Msg3) responsive to Msg2). The RACH procedure continues with the UE transmitting an initial RACH Msg3 indicating a connection request and/or a scheduling request. The base station responds with a RACH message four (Msg4) transmission for contention resolution. Such wireless communication systems may support the RACH Msg3 using repetitions via intra-slot frequency hopping techniques, but may not support inter-slot frequency hopping for the RACH Msg3 repetitions and/or details specifying how such inter-/intra-slot frequency hopping might be performed.

Aspects of the disclosure are initially described in the context of wireless communication systems. Generally, the described techniques provide for improved frequency hopping for PUSCH Msg3 repetitions. For example, a UE may transmit a RACH preamble to a base station, and may receive a grant for the RACH Msg3 transmission with repetitions in response. The grant may be a RACH Msg2 grant (e.g., a RAR) and/or may be a downlink control information (DCI) grant (e.g., DCI format 1_0 or 0_0). The grant may carry or otherwise indicate intra-slot frequency hopping flags and inter-slot frequency hopping flags. Generally, each frequency hopping flag may include one or more bits (e.g., repurposed bits and/or reserved bits) indicating whether intra-slot and/or inter-slot frequency hopping is configured for the RACH Msg3 repetitions. The UE may identify the frequency hopping configuration(s) for the RACH Msg3 repetition transmissions according to one or both flags indicated in the grant and transmit repetitions of the RACH Msg3 according to the frequency hopping configuration. For example, the UE may transmit initial and/or retransmission repetitions of the RACH Msg3 according to the inter-slot and/or intra-slot frequency hopping.

Aspects of the disclosure are further illustrated by and described with reference to apparatus diagrams, system diagrams, and flowcharts that relate to frequency hopping considerations for Msg3 PUSCH repetitions.

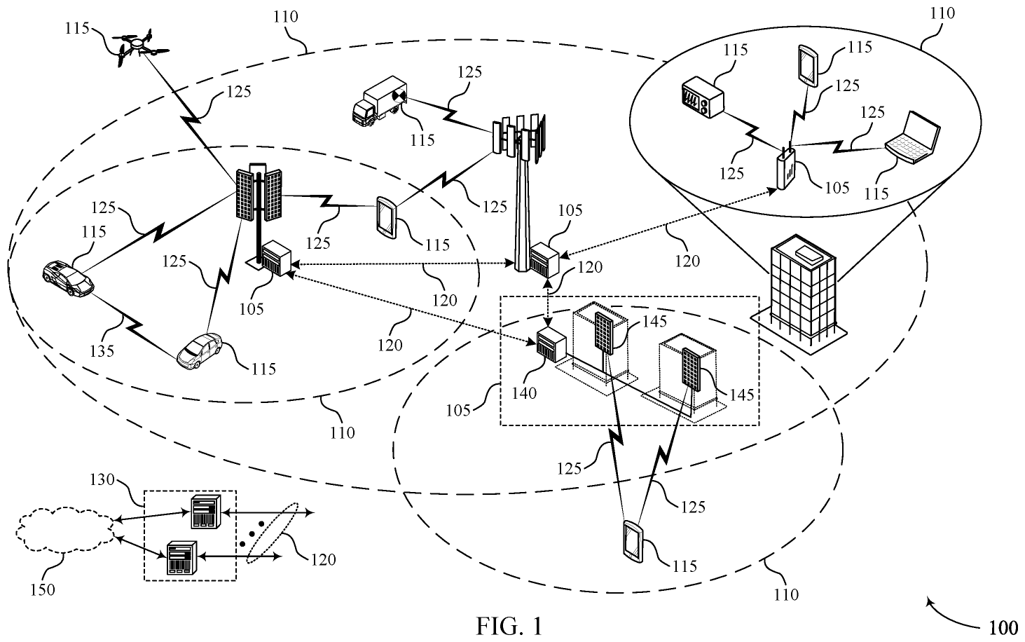

FIG. 1 illustrates an example of a wireless communication system 100 that supports frequency hopping considerations for Msg3 PUSCH repetitions in accordance with aspects of the present disclosure. The wireless communication system 100 may include one or more base stations 105, one or more UEs 115, and a core network 130. In some examples, the wireless communication system 100 may be a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or another interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T, =1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may transmit a RACH preamble to a base station 105. The UE 115 may receive, from the base station 105 and in response to the RACH preamble, a grant comprising a first frequency hopping indication associated with intra-slot frequency hopping and a second frequency hopping indication associated with inter-slot frequency hopping. The UE 115 may identify, based at least in part on the first frequency hopping indication or the second frequency hopping indication, a frequency hopping configuration for transmission of repetitions of an uplink transmission responsive to the grant. The UE 115 may transmit the repetitions of the uplink transmission using one or more frequency hops in accordance with the frequency hopping configuration.

A base station 105 may receive a RACH preamble from a UE 115. The base station 105 may transmit, to the UE 115 and in response to the RACH preamble, a grant comprising a first frequency hopping indication associated with intra-slot frequency hopping and a second frequency hopping indication associated with inter-slot frequency hopping that identifies a frequency hopping configuration for transmission of repetitions of an uplink transmission from the UE 115 responsive to the grant. The base station 105 may receive the repetitions of the uplink transmission using one or more frequency hops in accordance with the frequency hopping configuration.

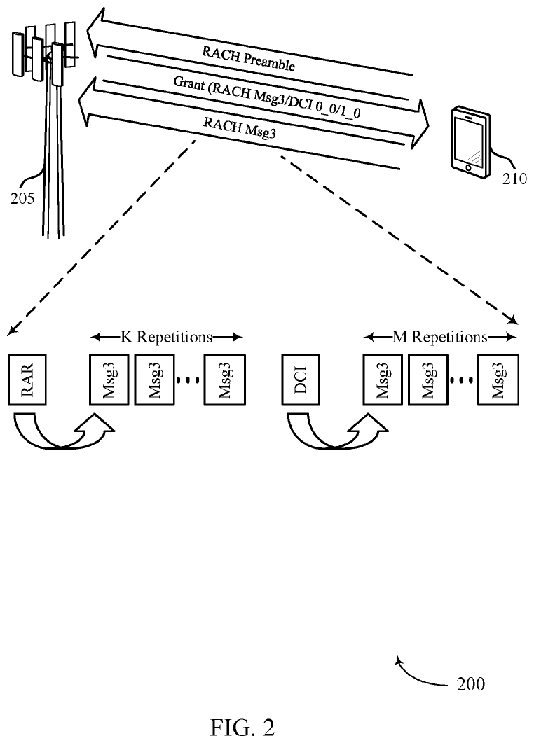

FIG. 2 illustrates an example of a wireless communication system 200 that supports frequency hopping considerations for Msg3 PUSCH repetitions in accordance with aspects of the present disclosure. Wireless communication system 200 may implement aspects of wireless communication system 100. Wireless communication system 200 may include base station 205 and/or UE 210, which may be examples of the corresponding devices described herein.

Wireless communication systems typically support a four-step RACH procedure between base station 205 and UE 210. Broadly, the RACH procedure allows UE 210 to connect to the network via base station 205 using the wireless connection established using the RACH procedure. The RACH procedure may provide for synchronization (both uplink and downlink) between base station 205 and UE 210, scheduling information, and the like. The four-step RACH procedure, as the name implies, utilizes at least four messages exchanged between base station 205 and UE 210.

The first step typically involves UE 210 transmitting RACH Msg1, which is also referred to as a RACH preamble. The RACH preamble may signal, to base station 205, that UE 210 is located proximate to base station 205 and is attempting to establish a wireless connection with base station 205 via the RACH procedure. The RACH preamble may be transmitted on a physical random access channel (PRACH).

The next step typically involves base station 205 responding to the RACH preamble by transmitting a RACH Msg2, which is also referred to as a RAR. The RAR may be transmitted via a downlink channel (e.g., PDCCH and/or PDSCH) that identifies timing advance information (e.g., synchronization information), an uplink grant of resources for a RACH Msg3 transmission from UE 210, identification information (e.g., a temporary cell random network temporary identifier (TC-RNTI)), and the like. For example, base station 205 may, upon receiving the RACH preamble, identify the TC-RNTI as well as uplink and downlink scheduling resources for UE 210. Base station 205 may transmit the RAR to UE 210 indicating the timing alignment information, identifier, and the like, for UE 210 (and other UEs as well, in some examples).

Upon receiving the RAR, UE 210 may transmit a RACH Msg3 to base station 205, which may carry or otherwise convey an RRC connection request, a scheduling request (SR), a buffer status report (BSR), and the like. For example, UE 210 may determine that it has received a response (e.g., the RAR) that includes a same identifier as was transmitted in the RACH preamble (e.g., a random access (RA)-preamble identifier) and, based on the match, transmit its uplink scheduling information in the RACH Msg3. The RACH Msg3 transmission may occur via PUSCH. The RACH Msg3 may also be referred to as an uplink transmission herein.

Base station 205 may respond by transmitting a RACH Msg4 to UE 210 via PDCCH and/or PDSCH for contention resolution. For example, base station 205 may initiate a contention resolution timer in response to receiving the RACH Msg3. If base station 205 and UE 210 complete contention resolution before the timer expires, UE 210 may establish a wireless connection with base station 205. If the timer expires before contention resolution is completed, the RACH procedure may be retried and/or UE 210 may attempt another RACH procedure with a different base station.

Wireless communication system 200 may support PUSCH repetitions for RACH Msg3 transmissions (which may also be referred to simply as uplink transmission(s) herein). This may include, for Msg3 PUSCH transmission, an initial transmission being scheduled by the uplink grant scheduling resources indicated in RAR (e.g., the scheduling resource indicated in RACH Msg2). Retransmissions of Msg3 PUSCH may be scheduled by a DCI format 0_0 with CRC scrambled by a TC-RNTI in the corresponding RAR. On the other hand, for other PUSCH (e.g., PUSCH scheduled by DCI format 0_1 in PDCCH with CRC scrambled with C-RNTI, MCS-C-RNTI, or CS-RNTI with new data indicator (NDI)=1), PUSCH transmission may be repeated to provide coverage extension and reliability (e.g., PUSCH repetition Type A). That is, when UE 210 transmits PUSCH scheduled by DCI format 0_1 in PDCCH with CRC scrambled with C-RNTI, MCS-C-RNTI, or with CS-RNTI with NDI=1, if UE 210 is configured with pusch-AggregationFactor consecutive slots and the PUSCH is limited to a single transmission layer, UE 210 may repeat the transport block (TB) across the pusch-AggregationFactor consecutive slots applying the same symbol allocation in each slot. PUSCH Type B may use different symbol allocations in slots applied across the PUSCH transmissions.

To support frequency hopping of the PUSCH transmissions (e.g., the uplink/RACH Msg3 transmissions), the frequency hopping may be configured in RAR/Msg2 for the RACH Msg3 initial transmission or in DCI format 0_0 with CRC scrambled by TC-RNTI for the Msg3 retransmission. Conventionally, frequency hopping is only configurable for intra-slot frequency hopping. The frequency offset (RB_offset) value for the intra-slot frequency hopping may depend on the size of the initial uplink bandwidth part (BWP), e.g., two possible offsets with BWP<50 RBs or four possible offsets with BWP>=50 RBs. For example, the RAR and/or DCI format 0_0 with CRC scrambled by TC-RNTI for the Msg3 retransmission may carry or otherwise convey a one-bit frequency hopping flag that when set configures (e.g., enables or activates) the intra-slot frequency hopping. Accordingly, the repetition configuration (e.g., the number of repetitions, frequency hopping, etc.) may be indicated in the RAR or DCI format 1_0 with CRC scrambled by RA-RNTI for the initial RACH Msg3 transmission or the RACH Msg3 retransmission or DCI format 0_0 with CRC scrambled by TC-RNTI for the RACH Msg3 retransmission.

However, such techniques may not provide any indication/mechanism to support such frequency hopping for the repeated Msg3 transmissions (initial transmission or retransmission) to be performed. That is, while the RAR/DCI grant may, using such conventional techniques, indicate that intra-slot frequency hopping is enabled for the RACH Msg3 transmissions, the RAR/DCI grant do not provide any indication of how such frequency hopping might be performed within each repetition transmission. Moreover, such conventional techniques do not provide a mechanism for inter-slot frequency hopping for the RACH Msg3 initial transmission repetitions and/or the RACH Msg3 retransmission repetitions.

Accordingly, aspects of the described techniques provide for supporting both intra-slot and inter-slot frequency hopping for uplink transmission repetitions (e.g., RACH Msg3 transmission repetitions via PUSCH), initial and/or retransmission(s). For example, UE 210 may transmit a RACH preamble (e.g., RACH Msg1) to base station 205. The RACH preamble may include a RA-preamble identifier indication, explicit and/or implicitly indicated. Base station 205 may respond by transmitting, in response to the RACH preamble, a grant that implicitly and/or explicitly indicates a grant for resources for an uplink transmission (e.g., the RACH Msg3 initial transmission and/or retransmission(s)) with repetition. The grant may implicitly indicate and/or explicitly carry a first frequency hopping indication for intra-slot frequency hopping and a second frequency hopping indication for inter-slot frequency hopping. That is, the grant may configure or otherwise enable inter-slot and/or intra-slot frequency hopping for the uplink transmission repetitions responsive to the grant.

The inter- and intra-slot frequency hopping indications/flags carried or otherwise conveyed in the grant may be used by UE 210 to identify or otherwise determine a frequency hopping configuration for the initial transmission and/or retransmission(s) of the uplink transmission (e.g., the RACH Msg3 transmission via PUSCH). Broadly, the frequency hopping configuration may provide guidance for repetition transmissions of the uplink transmission using frequency hops within the same slot (e.g., for intra-slot frequency hopping) and/or across multiple slots (e.g., for inter-slot frequency hopping). Accordingly, UE 210 may transmit repetitions of the uplink transmissions to base station 205 using frequency hop(s) according to the frequency hopping configuration.

In some aspects, the described techniques may support the same starting RB (RB_start) and the same frequency offset (RB_offset) being used for the RACH Msg3 PUSCH repetitions within an initial transmission and/or retransmission with repetitions. For example, base station 205 and/or UE 210 may determine that the first frequency hopping indication is indicated, configured, or otherwise enabled in the grant (e.g., for intra-slot frequency hopping). Accordingly, UE 210 may transmit or otherwise provide (and base station 205 may receive or otherwise obtain) each repetition of the uplink transmission according to the frequency hopping configuration (e.g., using the same starting RB and the same frequency/RB offset).

In some aspects, the described techniques may support the same starting RB (RB_start) being used, but different frequency offset(s) (RB_offset) being used for the RACH Msg3 PUSCH repetitions within an initial transmission and/or retransmission with repetitions. For example, base station 205 and/or UE 210 may determine that the first frequency hopping indication is indicated, configured, or otherwise enabled in the grant (e.g., for intra-slot frequency hopping). Accordingly, UE 210 may transmit (and base station 205 may receive) each repetition of the uplink transmission according to the frequency hopping configuration (e.g., using the same starting RB, but a different frequency/RB offset for some or all of the repetition(s)).

Accordingly, in some examples UE 210 may, for initial transmission with repetition and/or retransmission with repetition, assume that the same starting RB (RB_start) and the same frequency offset (RB_offset) or a different frequency offset (RB_offset) are used for the Msg3 PUSCH repetitions within a transmission (initial transmission and/or retransmission).

In some examples, the grant may correspond to the RAR message indicating scheduling information for the uplink transmission with repetitions. For example, base station 205 may transmit a RAR message to UE 210 responsive to the RACH preamble that schedules K repetitions of the uplink transmission (e.g., the RACH Msg3 transmission with repetition via PUSCH).

In some examples, the grant may correspond to a DCI message scheduling M repetitions of the uplink transmission. For example, the grant may correspond to a DCI format 1_0 with CRC scrambled by RA-RNTI and/or a DCI format 0_0 with CRC scrambled by TC-RNTI. For example, base station 205 may transmit (and UE 210 may receive) the DCI message providing the first and second frequency hopping indications/flags for intra-slot and inter-slot, respectively, frequency hopping for the RACH Msg3 transmission with repetitions. In the example where the grant corresponds to the DCI message, this may include reserved bit(s) being used to indicate the second frequency hopping indication. The reserved bit(s) may include bits reserved for a particular purpose (e.g., the four HARQ process number bits and/or a NDI bit that are repurposed to indicate the second frequency hopping indication) and/or may include previously reserved bits (e.g., unused/reserved bits allocated to indicate the second frequency hopping indication).

In some examples, the first frequency hopping indication or the second frequency hopping indication may be indicated, configured, enabled, or otherwise present in the grant. That is, either the first frequency hopping indication/flag for intra-slot frequency hopping or the second frequency hopping indication/flag for inter-slot frequency hopping may be present in the grant (e.g., RAR and/or DCI grant). For example, base station 205 may determine that either intra-slot frequency hopping or inter-slot frequency hopping may be used for the RACH Msg3 initial transmission and/or retransmission with repetition. Accordingly, base station 205 may configure the grant to indicate either the first or the second frequency hopping indication/flag.

In some examples, the RACH Msg3 initial transmission and/or retransmission may use different types of frequency hopping. That is, the frequency hopping configuration may include intra-slot frequency hopping configured for the initial RACH Msg3 PUSCH transmission while inter-slot frequency hopping may be configured for the retransmission of RACH Msg3 PUSCH with repetition, or vice versa. Moreover, different frequency hopping configurations may be used for different retransmissions of the RACH Msg3 PUSCH with repetition. For example, a first retransmission of RACH Msg3 PUSCH with repetition may use intra-slot frequency hopping while a second retransmission of RACH Msg3 PUSCH with repetition may use inter-slot frequency hopping, or vice versa. Accordingly, UE 210 may transmit each repetition of an initial transmission and/or first retransmission of the uplink transmission using intra-slot frequency hopping based on the first frequency hopping indication and then transmit each repetition of a second retransmission of the uplink transmission using inter-slot frequency hopping based on the second frequency hopping indication, or vice versa. In other examples, the initial transmission and/or retransmissions may use the same frequency hopping configuration.

Accordingly, in some examples base station 205 may set one or both of the first and second frequency hopping indications/flags in the grant transmitted to UE 210. In the situation where base station 205 sets (e.g., enables) both indications/flags, UE 210 may apply intra-slot frequency hopping for the uplink transmission with repetition according to the first frequency hopping indication/flag or may apply inter-slot frequency hopping for the uplink transmission with repetition according to the second frequency hopping indication/flag. That is, UE 210 may determine that both the first frequency hopping indication/flag and the second frequency hopping indication/flag are present in the grant and select the frequency hopping configuration based on the first or the second frequency hopping indication/flag.

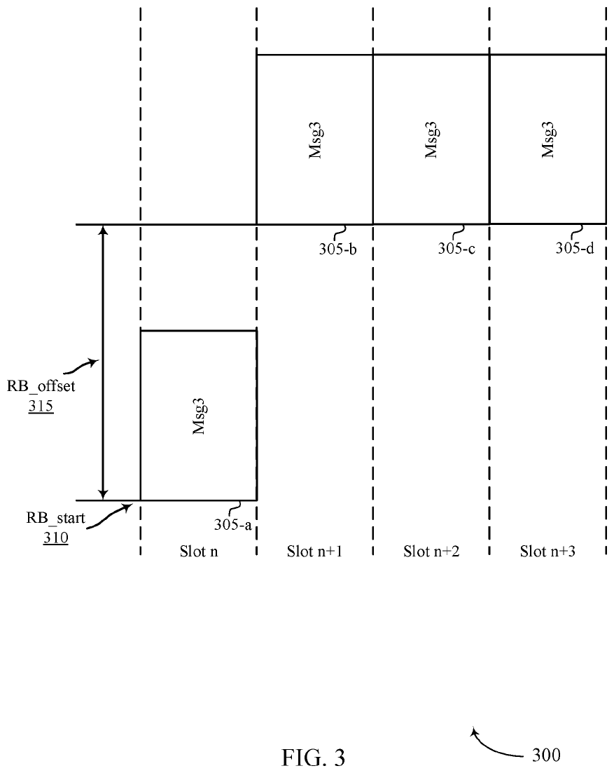

FIG. 3 illustrates an example of a frequency hopping configuration 300 that supports frequency hopping considerations for Msg3 PUSCH repetitions in accordance with aspects of the present disclosure. Frequency hopping configuration 300 may implement aspects of wireless communication systems 100 and/or 200. Aspects of frequency hopping configuration 300 may be implemented by or implemented at a UE and/or base station, which may be examples of the corresponding devices described herein.

Aspects of the described techniques provide for a grant scheduling resources for an uplink transmission (e.g., a RACH Msg3 PUSCH) with repetitions. The grant may be responsive to a RACH preamble transmitted by the UE and may also carry or otherwise convey a first frequency hopping indication/flag for intra-slot frequency hopping and a second frequency hopping indication/flag for inter-slot frequency hopping for the uplink transmission with repetitions. The grant may include a RAR message scheduling resources for the uplink transmission and/or a DCI grant scheduling resources for the uplink transmission and/or retransmission with repetition. The UE may select, determine, or otherwise identify a frequency hopping configuration for transmission of repetitions of the uplink transmission based on the first and/or second frequency hopping indications/flags. The UE may transmit the repetitions of the uplink transmission using one or more frequency hops in accordance with the frequency hopping configuration.

Frequency hopping configuration 300 illustrates one non-limiting example of a frequency hopping configuration that may be identified based on the grant. For example, frequency hopping configuration 300 illustrates an example of inter-slot frequency hopping is used for repetitions of the uplink transmission (e.g., Msg3 305) across four slots, although a different number of slots may be used. Accordingly, the UE may transmit a repetition of Msg3 305-a during slot n using a starting RB 310. The starting RB 310 may correspond to the first time/frequency resource used for the repetition of Msg3 305-a transmitted during slot n. In the non-limiting example illustrated in FIG. 3, each subsequent repetition of Msg3 305 may use the same starting RB 310 and the same frequency offset (e.g., RB offset 315). Accordingly, the next repetitions of Msg3 305-b, Msg3 305-c and Msg3 305-d transmitted during slot n+1, slot n+2, and slot n+3, respectively, may use the same starting resource block and the same frequency offset.

Although the frequency configuration 300 illustrates the Msg3 305 repetitions being transmitted across different slots (e.g., inter-slot frequency hopping), it is to be understood that these techniques may also be applied across different symbols of a single slot (e.g., intra-slot frequency hopping). In this example, the repetition of Msg3 305-a may be transmitted during a first subset of symbol(s) of the slot and the subsequent repetitions of Msg3 305-b, Msg3 305-c, and Msg3 305-d may be transmitted during other subsets of the symbol(s) of the slot. In this example, the intra-slot frequency hopping may use the same starting resource block and frequency offset for each subsequent repetition transmitted during the slot.

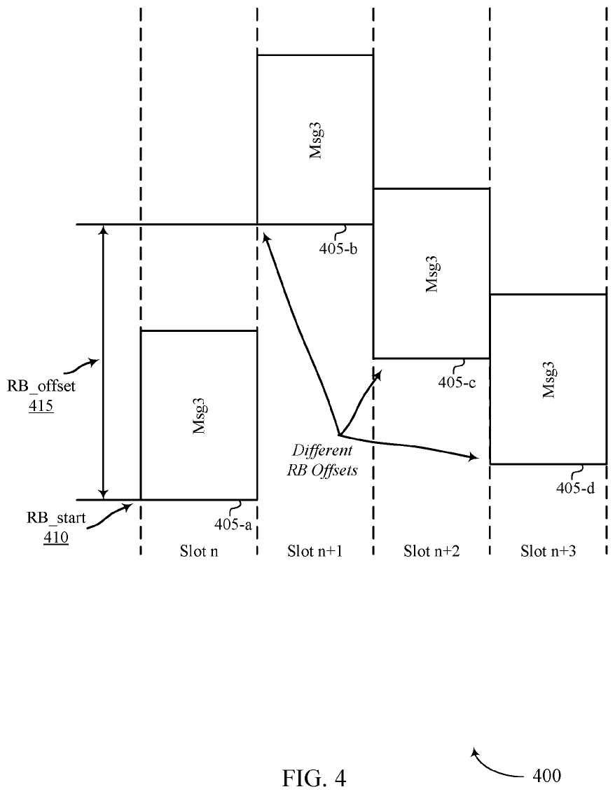

FIG. 4 illustrates an example of a frequency hopping configuration 400 that supports frequency hopping considerations for Msg3 PUSCH repetitions in accordance with aspects of the present disclosure. Frequency hopping configuration 400 may implement aspects of wireless communication systems 100 and/or 200 and/or frequency hopping configuration 300. Aspects of frequency hopping configuration 400 may be implemented by or implemented at a UE and/or base station, which may be examples of the corresponding devices described herein.

Aspects of the described techniques provide for a grant scheduling resources for an uplink transmission (e.g., a RACH Msg3 PUSCH) with repetitions. The grant may be responsive to a RACH preamble transmitted by the UE and may also carry or otherwise convey a first frequency hopping indication/flag for intra-slot frequency hopping and a second frequency hopping indication/flag for inter-slot frequency hopping for the uplink transmission with repetitions. The grant may include a RAR message scheduling resources for the uplink transmission and/or a DCI grant scheduling resources for the uplink transmission and/or retransmission with repetition. The UE may select, determine, or otherwise identify a frequency hopping configuration for transmission of repetitions of the uplink transmission based on the first and/or second frequency hopping indications/flags. The UE may transmit the repetitions of the uplink transmission using one or more frequency hops in accordance with the frequency hopping configuration.

Frequency hopping configuration 400 illustrates one non-limiting example of a frequency hopping configuration that may be identified based on the grant. For example, frequency hopping configuration 400 illustrates an example of inter-slot frequency hopping is used for repetitions of the uplink transmission (e.g., Msg3 405) across four slots, although a different number of slots may be used. Accordingly, the UE may transmit a repetition of Msg3 405-a during slot n using a starting RB 410. The starting RB 410 may correspond to the first time/frequency resource used for the repetition of Msg3 405-a transmitted during slot n. In the non-limiting example illustrated in FIG. 4, each subsequent repetition of Msg3 405 may use the same starting RB 405, but use different frequency offsets (e.g., RB offset 415). for example, the next repetitions of Msg3 405-b transmitted during slot n+1 may use a first frequency offset, Msg3 405-c transmitted during slot n+2 may use a second frequency offset, and Msg3 405-d transmitted during slot t n+3 may use a third frequency offset. Accordingly, the UE may transmit each repetition of the Msg3 according to the frequency hopping configuration 400 using the same starting RB 405, but using different frequency offsets.

Although the frequency configuration 400 illustrates the Msg3 405 repetitions being transmitted across different slots (e.g., inter-slot frequency hopping), it is to be understood that these techniques may also be applied across different symbols of a single slot (e.g., intra-slot frequency hopping). In this example, the repetition of Msg3 405-a may be transmitted during a first subset of symbol(s) of the slot and the subsequent repetitions of Msg3 405-b, Msg3 405-c, and Msg3 405-d may be transmitted during other subsets of the symbol(s) of the slot. In this example, the intra-slot frequency hopping may use the same starting resource block, but different frequency offsets for each subsequent repetition transmitted during the slot.

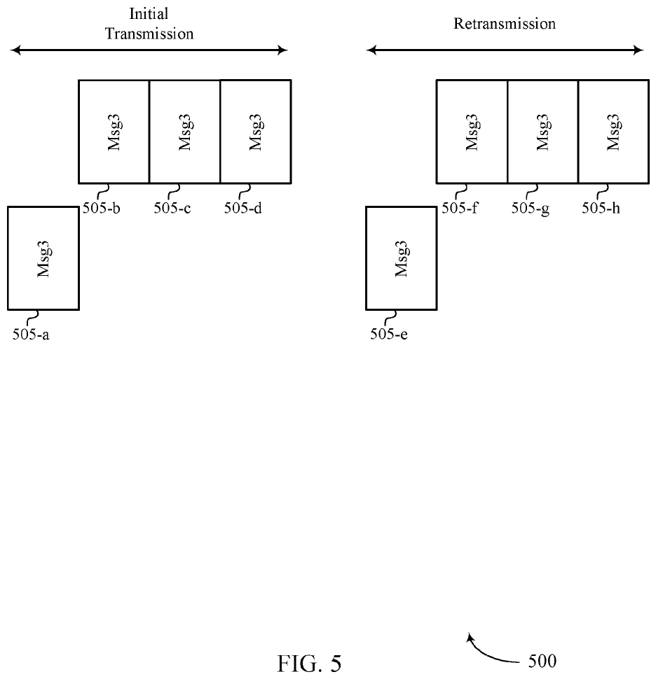

FIG. 5 illustrates an example of a frequency hopping configuration 500 that supports frequency hopping considerations for Msg3 PUSCH repetitions in accordance with aspects of the present disclosure. Frequency hopping configuration 500 may implement aspects of wireless communication systems 100 and/or 200 and/or frequency hopping configurations 300 and/or 400. Aspects of frequency hopping configuration 500 may be implemented by or implemented at a UE and/or base station, which may be examples of the corresponding devices described herein.

Aspects of the described techniques provide for a grant scheduling resources for an uplink transmission (e.g., a RACH Msg3 PUSCH) with repetitions. The grant may be responsive to a RACH preamble transmitted by the UE and may also carry or otherwise convey a first frequency hopping indication/flag for intra-slot frequency hopping and a second frequency hopping indication/flag for inter-slot frequency hopping for the uplink transmission with repetitions. The grant may include a RAR message scheduling resources for the uplink transmission and/or a DCI grant scheduling resources for the uplink transmission and/or retransmission with repetition. The UE may select, determine, or otherwise identify a frequency hopping configuration for transmission of repetitions of the uplink transmission based on the first and/or second frequency hopping indications/flags. The UE may transmit the repetitions of the uplink transmission using one or more frequency hops in accordance with the frequency hopping configuration.

Frequency hopping configuration 500 illustrates one non-limiting example of a frequency hopping configuration that may be identified based on the grant. For example, frequency hopping configuration 500 illustrates an example of inter-slot and/or intra-slot frequency hopping used for repetitions of the uplink transmission (e.g., Msg3 505). More particularly, frequency hopping configuration 500 illustrates an example where the initial transmission of repetitions of Msg3 505 and retransmission of repetitions of Msg3 505 use the same frequency hopping configuration. Additionally, or alternatively, frequency hopping configuration 500 illustrates an example where both the initial transmission and retransmission of Msg3 505 using the same starting RB (RB_start) and frequency offset (e.g., RB_offset).

Accordingly and for the initial transmission, the UE may transmit a repetition of Msg3 505-a using a starting RB. The starting RB may correspond to the first time/frequency resource used for the repetition of Msg3 505-a. The UE may transmit one or more repetitions of Msg3 505 according to the frequency hopping configuration 500. For example, the UE may transmit a first repetition of Msg3 505-b using the same starting RB and a frequency offset with respect to the Msg3 505-a transmission. The UE may transmit a second repetition of Msg3 505-c and Msg3 505-d using the same starting RB and the same frequency offset as the Msg3 505-b.

For the retransmission, the UE may transmit a repetition of Msg3 505-e using a starting RB. The starting RB may correspond to the first time/frequency resource used for the repetition of Msg3 505-d. The UE may transmit one or more repetitions of Msg3 505 according to the frequency hopping configuration 500. For example, the UE may transmit a first repetition of Msg3 505-f using the same starting RB and a frequency offset with respect to the Msg3 505-e transmission. The UE may transmit a second repetition of Msg3 505-g and Msg3 505-h using the same starting RB and the same frequency offset as the Msg3 505-f.

It is to be understood that these techniques may be applied across different symbols of a single slot (e.g., intra-slot frequency hopping) and/or across different slots (e.g., inter-slot hopping). Accordingly, frequency hopping configuration 500 illustrates an example where the initial transmission and retransmission use the same frequency hopping configuration.

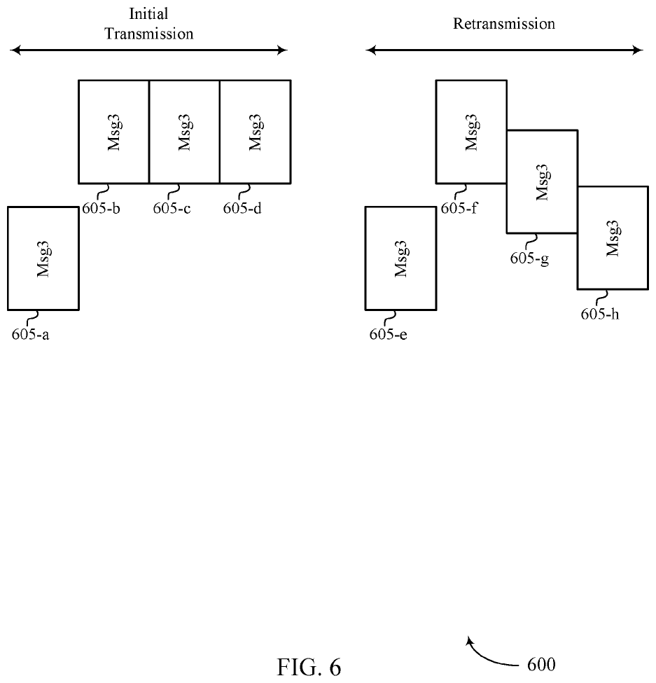

FIG. 6 illustrates an example of a frequency hopping configuration 600 that supports frequency hopping considerations for Msg3 PUSCH repetitions in accordance with aspects of the present disclosure. Frequency hopping configuration 600 may implement aspects of wireless communication systems 100 and/or 200 and/or frequency hopping configurations 300, 400 and/or 500. Aspects of frequency hopping configuration 600 may be implemented by or implemented at a UE and/or base station, which may be examples of the corresponding devices described herein.

Aspects of the described techniques provide for a grant scheduling resources for an uplink transmission (e.g., a RACH Msg3 PUSCH) with repetitions. The grant may be responsive to a RACH preamble transmitted by the UE and may also carry or otherwise convey a first frequency hopping indication/flag for intra-slot frequency hopping and a second frequency hopping indication/flag for inter-slot frequency hopping for the uplink transmission with repetitions. The grant may include a RAR message scheduling resources for the uplink transmission and/or a DCI grant scheduling resources for the uplink transmission and/or retransmission with repetition. The UE may select, determine, or otherwise identify a frequency hopping configuration for transmission of repetitions of the uplink transmission based on the first and/or second frequency hopping indications/flags. The UE may transmit the repetitions of the uplink transmission using one or more frequency hops in accordance with the frequency hopping configuration.

Frequency hopping configuration 600 illustrates one non-limiting example of a frequency hopping configuration that may be identified based on the grant. For example, frequency hopping configuration 600 illustrates an example of inter-slot and/or intra-slot frequency hopping used for repetitions of the uplink transmission (e.g., Msg3 605). More particularly, frequency hopping configuration 600 illustrates an example where the initial transmission of repetitions of Msg3 605 uses a first frequency hopping configuration and retransmission of repetitions of Msg3 605 uses a second frequency hopping configuration. Additionally, or alternatively, frequency hopping configuration 600 illustrates an example where both the initial transmission of Msg3 605 uses the same starting RB (RB_start) and frequency offset (RB_offset) and retransmission of Msg3 605 using the same starting RB (RB_start), but different frequency offsets (e.g., RB_offset).

Accordingly and for the initial transmission, the UE may transmit a repetition of Msg3 605-a using a starting RB. The starting RB may correspond to the first time/frequency resource used for the repetition of Msg3 605-a. The UE may transmit one or more repetitions of Msg3 605 according to the first frequency hopping configuration. For example, the UE may transmit a first repetition of Msg3 605-b using the same starting RB and a frequency offset with respect to the Msg3 605-a transmission. The UE may transmit a second repetition of Msg3 605-c and Msg3 605-d using the same starting RB and the same frequency offset as the Msg3 605-b.

For the retransmission, the UE may transmit a repetition of Msg3 605-e using a starting RB. The starting RB may correspond to the first time/frequency resource used for the repetition of Msg3 605-d. The UE may transmit one or more repetitions of Msg3 605 according to the second frequency hopping configuration. Frequency hopping configuration 500 may include both the first frequency hopping configuration used for the initial transmission and the second frequency hopping configuration used for the retransmission. For example, the UE may transmit a first repetition of Msg3 605-f using the same starting RB and a frequency offset with respect to the Msg3 605-e transmission. The UE may transmit a second repetition of Msg3 605-g using a starting RB, but a different frequency offset with respect to the Msg3 605-f transmission. The UE may transmit a third repetition of Msg3 605-h using a starting RB, but a different frequency offset with respect to the Msg3 605-g transmission.

It is to be understood that these techniques may be applied across different symbols of a single slot (e.g., intra-slot frequency hopping) and/or across different slots (e.g., inter-slot hopping). Accordingly, frequency hopping configuration 600 illustrates an example where the initial transmission and retransmission use different frequency hopping configurations.

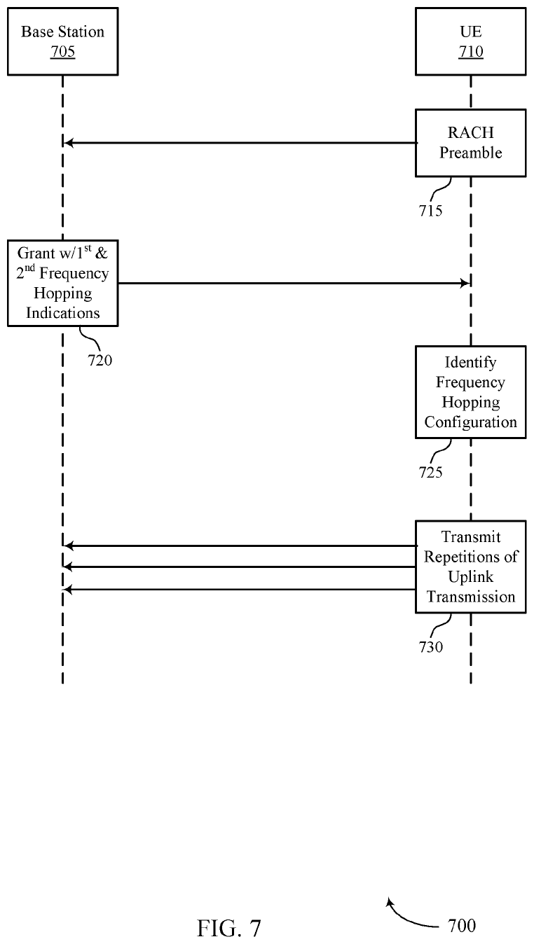

FIG. 7 illustrates an example of a process 700 that supports frequency hopping considerations for Msg3 PUSCH repetitions in accordance with aspects of the present disclosure. Process 700 may implement aspects of wireless communication systems 100 and/or 200 and/or frequency hopping configurations 300, 400, 500, and/or 600. Aspects of process 700 may be implemented at or implemented by base station 705 and/or UE 710, which may be examples of the corresponding devices described herein.

At 715, UE 710 may transmit or otherwise provide (and base station 705 may receive or otherwise obtain) a RACH preamble. The RACH preamble may generally initiate a RACH procedure between base station 705 and UE 710 in order to establish a wireless connection for communications.

At 720, base station 705 may transmit or otherwise provide (and UE 710 may receive or otherwise obtain) a grant comprising a first frequency hopping indication associated with intra-slot frequency hopping and a second frequency hopping indication associated with inter-slot frequency hopping. In some aspects, the grant may be responsive to the RACH preamble transmitted by UE 710. In some aspects, the grant may include a RAR responsive to the RACH preamble and/or may include a DCI message scheduling resources for the uplink transmission with repetitions. For example, the grant may include a DCI message including a CRC scrambled by either a RA-RNTI or a TC-RNTI. In some aspects, the DCI message may include reserved bits indicating the first and/or second frequency hopping indications (e.g., bits reserved for a particular purpose that are repurposed to provide the indication and/or otherwise reserved/unused bits).

At 725, UE 710 may identify or otherwise determine a frequency hopping configuration for transmission of repetitions of an uplink transmission (e.g., a RACH Msg3 PUSCH transmission) responsive to the grant. For example, UE 710 may identify or otherwise determine the frequency hopping configuration based on the first frequency hopping indication and/or the second frequency hopping indication carried or otherwise conveyed in the grant.

At 730, UE 710 may transmit or otherwise provide (and base station 705 may receive or otherwise obtain) the repetitions of the uplink transmission using one or more frequency hopped in accordance with the frequency hopping configuration (with three repetitions being shown by way of example only).

In some aspects, this may include UE 710 determining that the first frequency hopping indication associated with intra-slot frequency hopping is present or otherwise configured by the grant. In this example, UE 710 may transmit each repetition of the uplink transmission according to the frequency hopping configuration using the same starting RB (e.g., RB_start) and the same frequency offset (e.g., RB_offset).

In some aspects, this may include UE 710 determining that the first frequency hopping indication associated with intra-slot frequency hopping is present or otherwise configured in the grant. In this example, UE 710 may transmit each repetition of the uplink transmission according to the frequency hopping configuration using a same starting RB, but different frequency offsets.

In some aspects, this may include UE 710 transmit each repetition of an initial transmission and/or retransmission of the uplink transmission based on the first frequency hopping indication (e.g., using intra-slot frequency hopping) and then transmitting each repetition of a second retransmission of the uplink transmission based on the second frequency hopping indication (e.g., using inter-slot frequency hopping), or vice versa.

In some aspects, this may include UE 710 determining that both the first frequency hopping indication for intra-slot frequency hopping and the second frequency hopping indication for inter-slot frequency hopping are present or are otherwise configured in the grant. In this example, UE 710 may select the frequency hopping configuration based on the first frequency hopping indication and/or the second frequency hopping indication (e.g., may use intra-slot frequency hopping and/or inter-slot frequency hopping) for transmitting the repetitions of the uplink transmission.

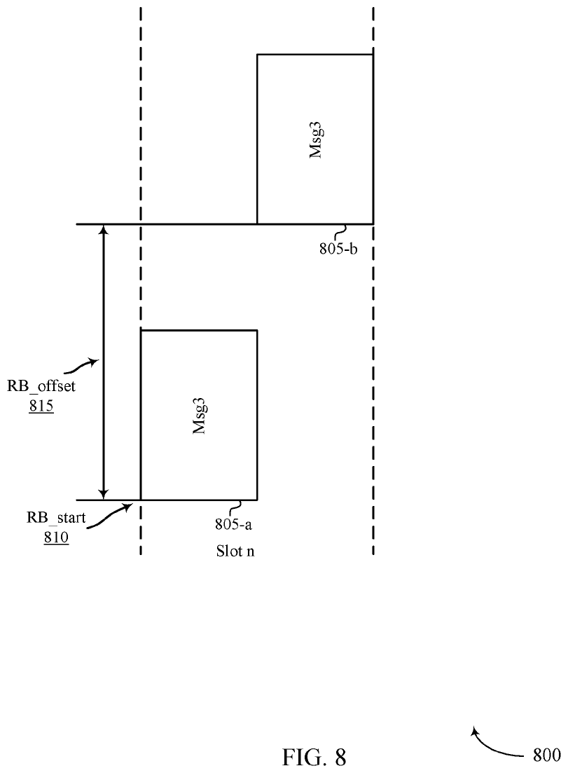

FIG. 8 illustrates an example of a frequency hopping configuration 800 that supports frequency hopping considerations for Msg3 PUSCH repetitions in accordance with aspects of the present disclosure. Frequency hopping configuration 800 may implement aspects of wireless communication systems 100 and/or 200, frequency hopping configurations 300, 400, 500, and/or 600, and/or process 700. Aspects of frequency hopping configuration 800 may be implemented by or implemented at a UE and/or base station, which may be examples of the corresponding devices described herein.

Aspects of the described techniques provide for a grant scheduling resources for an uplink transmission (e.g., a RACH Msg3 PUSCH) with repetitions. The grant may be responsive to a RACH preamble transmitted by the UE and may also carry or otherwise convey a first frequency hopping indication/flag for intra-slot frequency hopping and a second frequency hopping indication/flag for inter-slot frequency hopping for the uplink transmission with repetitions. The grant may include a RAR message scheduling resources for the uplink transmission and/or a DCI grant scheduling resources for the uplink transmission and/or retransmission with repetition. The UE may select, determine, or otherwise identify a frequency hopping configuration for transmission of repetitions of the uplink transmission based on the first and/or second frequency hopping indications/flags. The UE may transmit the repetitions of the uplink transmission using one or more frequency hops in accordance with the frequency hopping configuration.

Frequency hopping configuration 800 illustrates one non-limiting example of a frequency hopping configuration that may be identified based on the grant. For example, frequency hopping configuration 800 illustrates an example of intra-slot frequency hopping used for repetitions of the uplink transmission (e.g., Msg3 805) across a slot. Accordingly, the UE may transmit a repetition of Msg3 805-a during a first one or more symbols of slot n using a starting RB 810. The starting RB 810 may correspond to the first time/frequency resource used for the repetition of Msg3 805-a transmitted during the first one or more symbols of slot n. The next repetition of Msg3 805-b transmitted during a second one or more symbols of slot n may use the same starting resource block, and may be offset in the frequency domain according to the frequency offset designated by RB offset 815 (e.g., RB_offset).

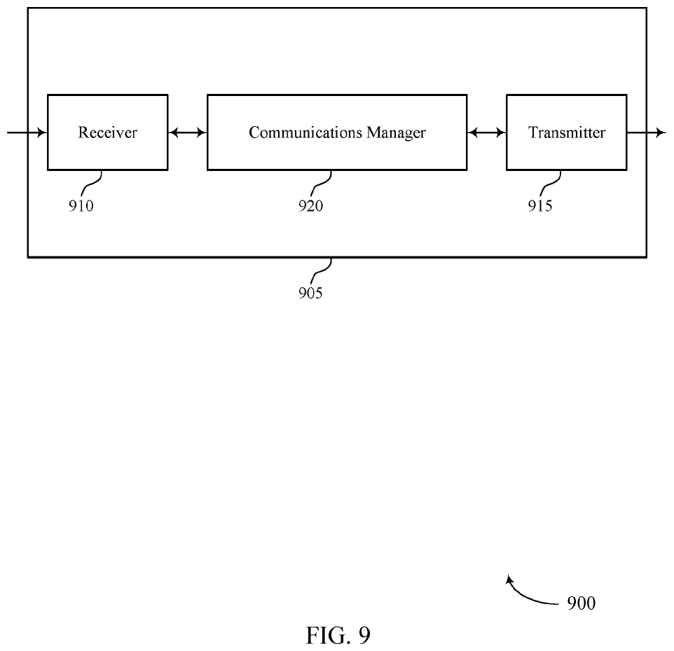

FIG. 9 shows a block diagram 900 of a device 905 that supports frequency hopping considerations for Msg3 PUSCH repetitions in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to frequency hopping considerations for Msg3 PUSCH repetitions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to frequency hopping considerations for Msg3 PUSCH repetitions). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of frequency hopping considerations for Msg3 PUSCH repetitions as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. For example, the communications manager 920 may be configured as or otherwise support a means for transmitting a random access channel preamble to a base station. The communications manager 920 may be configured as or otherwise support a means for receiving, from the base station and in response to the random access channel preamble, a grant including a first frequency hopping indication associated with intra-slot frequency hopping and a second frequency hopping indication associated with inter-slot frequency hopping. The communications manager 920 may be configured as or otherwise support a means for identifying, based on the first frequency hopping indication or the second frequency hopping indication, a frequency hopping configuration for transmission of repetitions of an uplink transmission responsive to the grant. The communications manager 920 may be configured as or otherwise support a means for transmitting the repetitions of the uplink transmission using one or more frequency hops in accordance with the frequency hopping configuration.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for signaling and/or configuring intra-slot frequency hopping as well as inter-slot frequency hopping for RACH Msg3 transmissions via PUSCH with repetition.

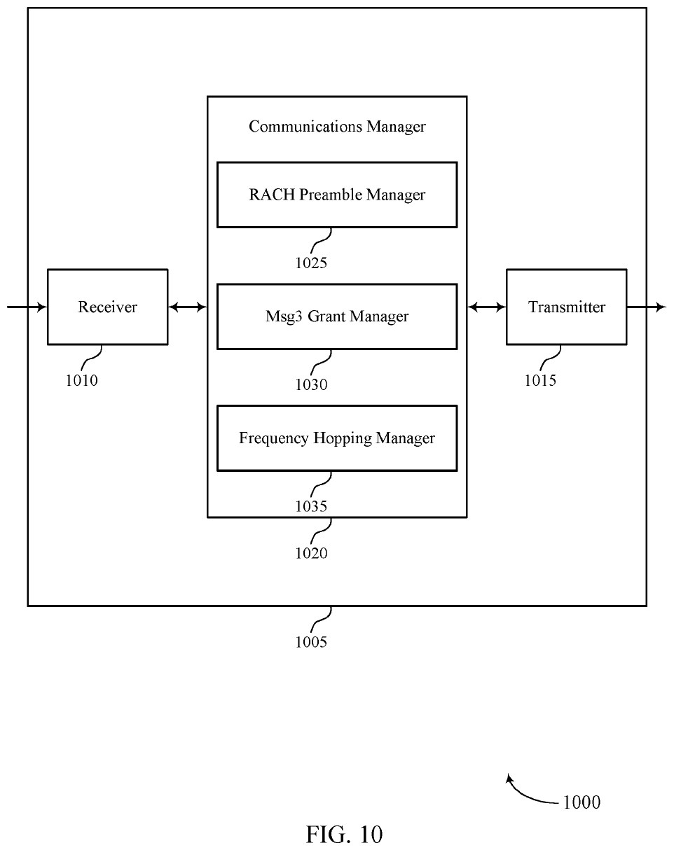

FIG. 10 shows a block diagram 1000 of a device 1005 that supports frequency hopping considerations for Msg3 PUSCH repetitions in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to frequency hopping considerations for Msg3 PUSCH repetitions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to frequency hopping considerations for Msg3 PUSCH repetitions). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of frequency hopping considerations for Msg3 PUSCH repetitions as described herein. For example, the communications manager 1020 may include a RACH preamble manager 1025, a Msg3 grant manager 1030, a frequency hopping manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a UE in accordance with examples as disclosed herein. The RACH preamble manager 1025 may be configured as or otherwise support a means for transmitting a random access channel preamble to a base station. The Msg3 grant manager 1030 may be configured as or otherwise support a means for receiving, from the base station and in response to the random access channel preamble, a grant including a first frequency hopping indication associated with intra-slot frequency hopping and a second frequency hopping indication associated with inter-slot frequency hopping. The frequency hopping manager 1035 may be configured as or otherwise support a means for identifying, based on the first frequency hopping indication or the second frequency hopping indication, a frequency hopping configuration for transmission of repetitions of an uplink transmission responsive to the grant. The frequency hopping manager 1035 may be configured as or otherwise support a means for transmitting the repetitions of the uplink transmission using one or more frequency hops in accordance with the frequency hopping configuration.

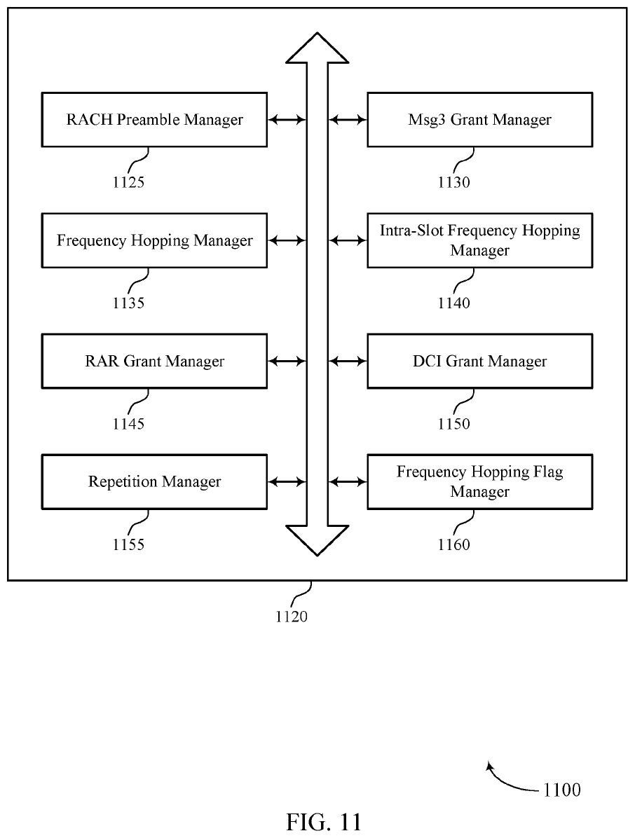

FIG. 11 shows a block diagram 1100 of a communications manager 1120 that supports frequency hopping considerations for Msg3 PUSCH repetitions in accordance with aspects of the present disclosure. The communications manager 1120 may be an example of aspects of a communications manager 920, a communications manager 1020, or both, as described herein. The communications manager 1120, or various components thereof, may be an example of means for performing various aspects of frequency hopping considerations for Msg3 PUSCH repetitions as described herein. For example, the communications manager 1120 may include a RACH preamble manager 1125, a Msg3 grant manager 1130, a frequency hopping manager 1135, an intra-slot frequency hopping manager 1140, a RAR grant manager 1145, a DCI grant manager 1150, a repetition manager 1155, a frequency hopping flag manager 1160, or any combination thereof. Each of these components may communicate, directly or indirectly, with one another (e.g., via one or more buses).

The communications manager 1120 may support wireless communication at a UE in accordance with examples as disclosed herein. The RACH preamble manager 1125 may be configured as or otherwise support a means for transmitting a random access channel preamble to a base station. The Msg3 grant manager 1130 may be configured as or otherwise support a means for receiving, from the base station and in response to the random access channel preamble, a grant including a first frequency hopping indication associated with intra-slot frequency hopping and a second frequency hopping indication associated with inter-slot frequency hopping. The frequency hopping manager 1135 may be configured as or otherwise support a means for identifying, based on the first frequency hopping indication or the second frequency hopping indication, a frequency hopping configuration for transmission of repetitions of an uplink transmission responsive to the grant. In some examples, the frequency hopping manager 1135 may be configured as or otherwise support a means for transmitting the repetitions of the uplink transmission using one or more frequency hops in accordance with the frequency hopping configuration.

In some examples, the intra-slot frequency hopping manager 1140 may be configured as or otherwise support a means for determining that the first frequency hopping indication associated with intra-slot frequency hopping is present in the grant. In some examples, the intra-slot frequency hopping manager 1140 may be configured as or otherwise support a means for transmitting each repetition of the uplink transmission according to the frequency hopping configuration using a same starting resource block and a same frequency offset.

In some examples, the intra-slot frequency hopping manager 1140 may be configured as or otherwise support a means for determining that the first frequency hopping indication associated with intra-slot frequency hopping is present in the grant. In some examples, the intra-slot frequency hopping manager 1140 may be configured as or otherwise support a means for transmitting each repetition of the uplink transmission according to the frequency hopping configuration using a same starting resource block and a different frequency offset.

In some examples, to support receiving the grant, the RAR grant manager 1145 may be configured as or otherwise support a means for receiving a random access response message.

In some examples, to support receiving the grant, the DCI grant manager 1150 may be configured as or otherwise support a means for receiving a downlink control information message that includes a cyclic redundancy check scrambled by either a random access radio network temporary identifier or a temporary cell random access radio network temporary identifier, where the second frequency hopping indication is included within reserved bits of the downlink control information message. In some examples, the reserved bits include bits reserved for at least one of a hybrid automatic repeat request process number or a new data indicator. In some examples, either the first frequency hopping indication or the second frequency hopping indication is configured for the uplink transmission by the grant.

In some examples, the repetition manager 1155 may be configured as or otherwise support a means for transmitting each repetition of an initial transmission, a first retransmission, or both, of the uplink transmission based on the first frequency hopping indication associated with intra-slot frequency hopping. In some examples, the repetition manager 1155 may be configured as or otherwise support a means for transmitting each repetition of a second retransmission of the uplink transmission based on the second frequency hopping indication associated with inter-slot frequency hopping.

In some examples, the repetition manager 1155 may be configured as or otherwise support a means for transmitting each repetition of an initial transmission, a first retransmission, or both, of the uplink transmission based on the second frequency hopping indication associated with inter-slot frequency hopping. In some examples, the repetition manager 1155 may be configured as or otherwise support a means for transmitting each repetition of a second retransmission of the uplink transmission based on the first frequency hopping indication associated with intra-slot frequency hopping.

In some examples, the frequency hopping flag manager 1160 may be configured as or otherwise support a means for determining that both the first frequency hopping indication associated with intra-slot frequency hopping and that the second frequency hopping indication associated with inter-slot frequency hopping are present in the grant. In some examples, the frequency hopping flag manager 1160 may be configured as or otherwise support a means for selecting the frequency hopping configuration based on the first frequency hopping indication.

In some examples, the frequency hopping flag manager 1160 may be configured as or otherwise support a means for determining that both the first frequency hopping indication associated with intra-slot frequency hopping and that the second frequency hopping indication associated with inter-slot frequency hopping are present in the grant. In some examples, the frequency hopping flag manager 1160 may be configured as or otherwise support a means for selecting the frequency hopping configuration based on the second frequency hopping indication.

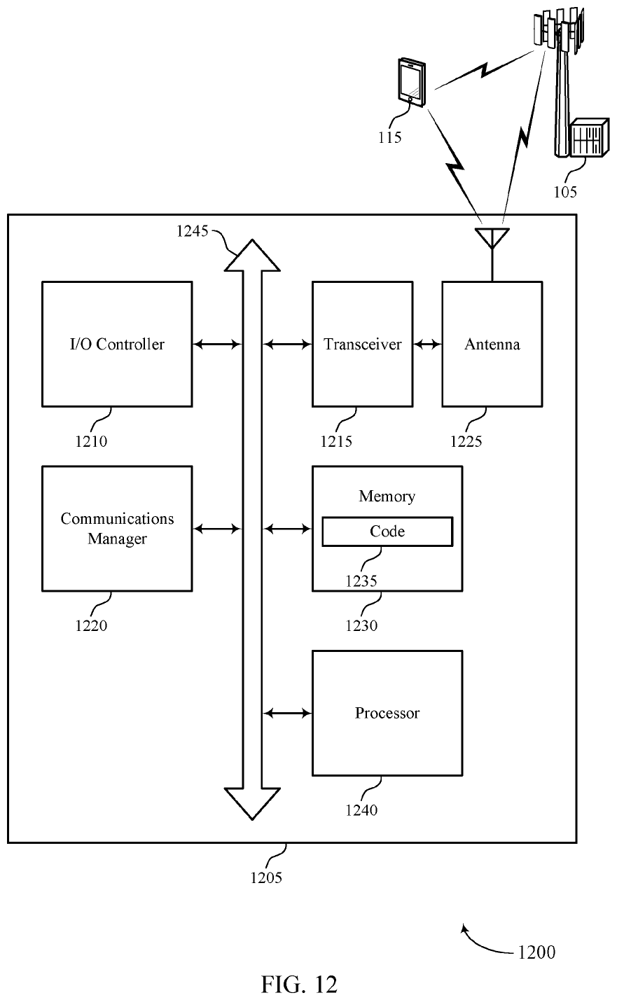

FIG. 12 shows a diagram of a system 1200 including a device 1205 that supports frequency hopping considerations for Msg3 PUSCH repetitions in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting frequency hopping considerations for Msg3 PUSCH repetitions). For example, the device 1205 or a component of the device 1205 may include a processor 1240 and memory 1230 coupled to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for transmitting a random access channel preamble to a base station. The communications manager 1220 may be configured as or otherwise support a means for receiving, from the base station and in response to the random access channel preamble, a grant including a first frequency hopping indication associated with intra-slot frequency hopping and a second frequency hopping indication associated with inter-slot frequency hopping. The communications manager 1220 may be configured as or otherwise support a means for identifying, based on the first frequency hopping indication or the second frequency hopping indication, a frequency hopping configuration for transmission of repetitions of an uplink transmission responsive to the grant. The communications manager 1220 may be configured as or otherwise support a means for transmitting the repetitions of the uplink transmission using one or more frequency hops in accordance with the frequency hopping configuration.

By including or configuring the communications manager 1220 in accordance with examples as described herein, the device 1205 may support techniques for signaling and/or configuring intra-slot frequency hopping as well as inter-slot frequency hopping for RACH Msg3 transmissions via PUSCH with repetition.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of frequency hopping considerations for Msg3 PUSCH repetitions as described herein, or the processor 1240 and the memory 1230 may be otherwise configured to perform or support such operations.

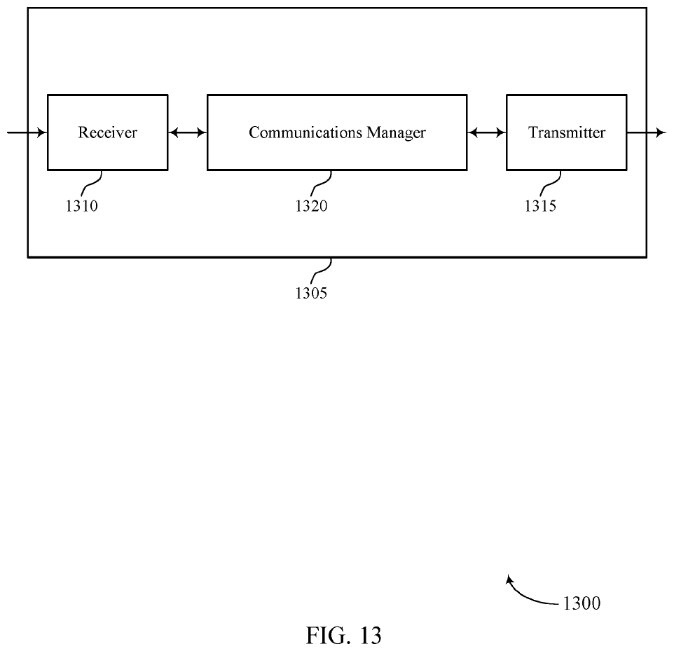

FIG. 13 shows a block diagram 1300 of a device 1305 that supports frequency hopping considerations for Msg3 PUSCH repetitions in accordance with aspects of the present disclosure. The device 1305 may be an example of aspects of a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to frequency hopping considerations for Msg3 PUSCH repetitions). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to frequency hopping considerations for Msg3 PUSCH repetitions). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of frequency hopping considerations for Msg3 PUSCH repetitions as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a base station in accordance with examples as disclosed herein. For example, the communications manager 1320 may be configured as or otherwise support a means for receiving a random access channel preamble from a UE. The communications manager 1320 may be configured as or otherwise support a means for transmitting, to the UE and in response to the random access channel preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant. The communications manager 1320 may be configured as or otherwise support a means for receiving the repetitions of the uplink transmission using one or more frequency hops in accordance with the frequency hopping configuration.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for signaling and/or configuring intra-slot frequency hopping as well as inter-slot frequency hopping for RACH Msg3 transmissions via PUSCH with repetition.

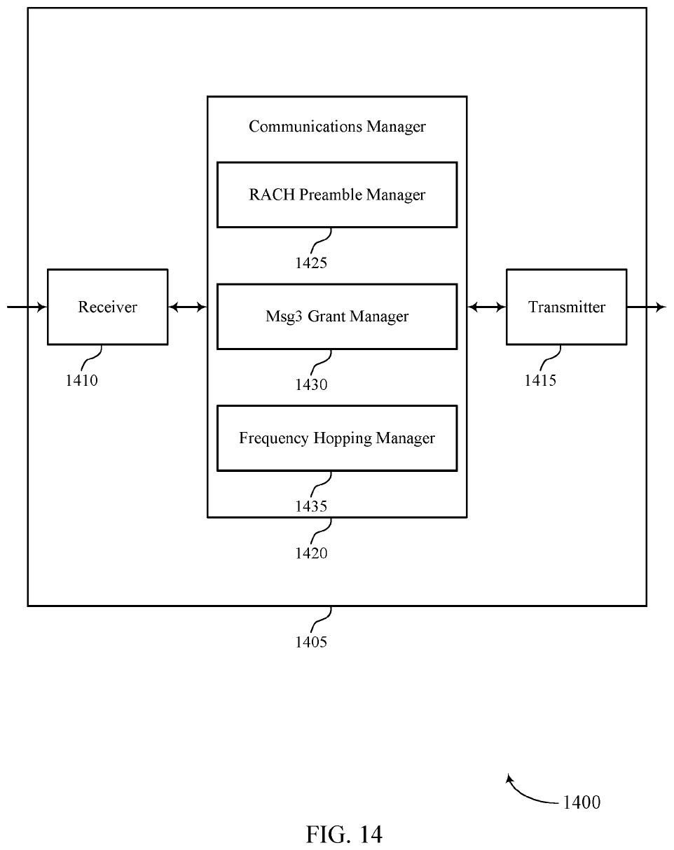

FIG. 14 shows a block diagram 1400 of a device 1405 that supports frequency hopping considerations for Msg3 PUSCH repetitions in accordance with aspects of the present disclosure. The device 1405 may be an example of aspects of a device 1305 or a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to frequency hopping considerations for Msg3 PUSCH repetitions). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to frequency hopping considerations for Msg3 PUSCH repetitions). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of frequency hopping considerations for Msg3 PUSCH repetitions as described herein. For example, the communications manager 1420 may include a RACH preamble manager 1425, a Msg3 grant manager 1430, a frequency hopping manager 1435, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication at a base station in accordance with examples as disclosed herein. The RACH preamble manager 1425 may be configured as or otherwise support a means for receiving a random access channel preamble from a UE. The Msg3 grant manager 1430 may be configured as or otherwise support a means for transmitting, to the UE and in response to the random access channel preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant. The frequency hopping manager 1435 may be configured as or otherwise support a means for receiving the repetitions of the uplink transmission using one or more frequency hops in accordance with the frequency hopping configuration.

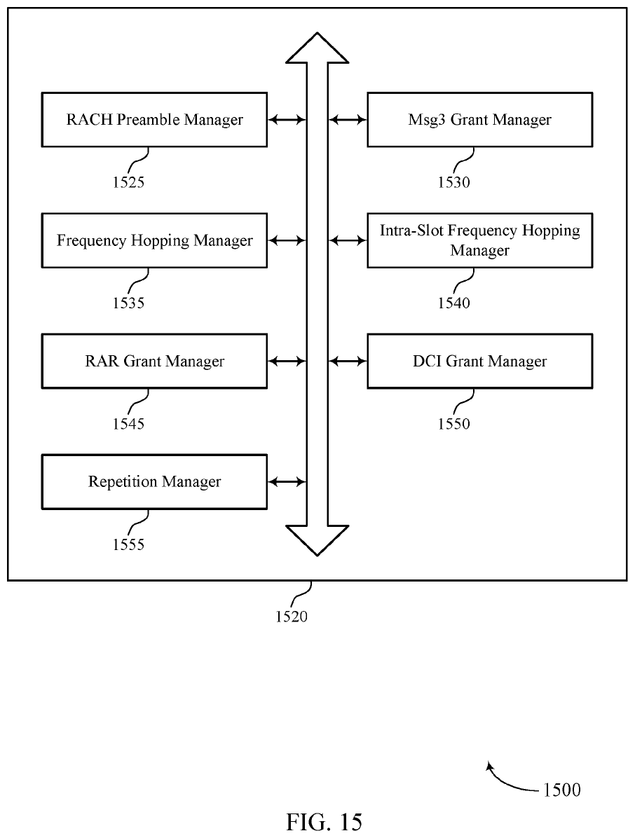

FIG. 15 shows a block diagram 1500 of a communications manager 1520 that supports frequency hopping considerations for Msg3 PUSCH repetitions in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of frequency hopping considerations for Msg3 PUSCH repetitions as described herein. For example, the communications manager 1520 may include a RACH preamble manager 1525, a Msg3 grant manager 1530, a frequency hopping manager 1535, an intra-slot frequency hopping manager 1540, a RAR grant manager 1545, a DCI grant manager 1550, a repetition manager 1555, or any combination thereof. Each of these components may communicate, directly or indirectly, with one another (e.g., via one or more buses).

The communications manager 1520 may support wireless communication at a base station in accordance with examples as disclosed herein. The RACH preamble manager 1525 may be configured as or otherwise support a means for receiving a random access channel preamble from a UE. The Msg3 grant manager 1530 may be configured as or otherwise support a means for transmitting, to the UE and in response to the random access channel preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant. The frequency hopping manager 1535 may be configured as or otherwise support a means for receiving the repetitions of the uplink transmission using one or more frequency hops in accordance with the frequency hopping configuration.

In some examples, the intra-slot frequency hopping manager 1540 may be configured as or otherwise support a means for receiving each repetition of the uplink transmission according to the frequency hopping configuration using a same starting resource block and a same frequency offset.

In some examples, the intra-slot frequency hopping manager 1540 may be configured as or otherwise support a means for receiving each repetition of the uplink transmission according to the frequency hopping configuration using a same starting resource block and a different frequency offset.

In some examples, to support transmitting the grant, the RAR grant manager 1545 may be configured as or otherwise support a means for transmitting a random access response message.

In some examples, to support transmitting the grant, the DCI grant manager 1550 may be configured as or otherwise support a means for transmitting a downlink control information message that includes a cyclic redundancy check scrambled by either a random access radio network temporary identifier or a temporary cell random access network temporary identifier, where the second frequency hopping indication is included within reserved bits of the downlink control information message.

In some examples, the reserved bits include bits reserved for at least one of a hybrid automatic repeat request process number or a new data indicator.

In some examples, either the first frequency hopping indication or the second frequency hopping indication is configured for the uplink transmission by the grant.

In some examples, the repetition manager 1555 may be configured as or otherwise support a means for receiving each repetition of an initial transmission, a first retransmission, or both, of the uplink transmission based on the first frequency hopping indication associated with intra-slot frequency hopping. In some examples, the repetition manager 1555 may be configured as or otherwise support a means for receiving each repetition of a second retransmission of the uplink transmission based on the second frequency hopping indication associated with inter-slot frequency hopping.

In some examples, the repetition manager 1555 may be configured as or otherwise support a means for receiving each repetition of an initial transmission, a first retransmission, or both, of the uplink transmission based on the second frequency hopping indication associated with inter-slot frequency hopping. In some examples, the repetition manager 1555 may be configured as or otherwise support a means for receiving each repetition of a second retransmission of the uplink transmission based on the first frequency hopping indication associated with intra-slot frequency hopping.

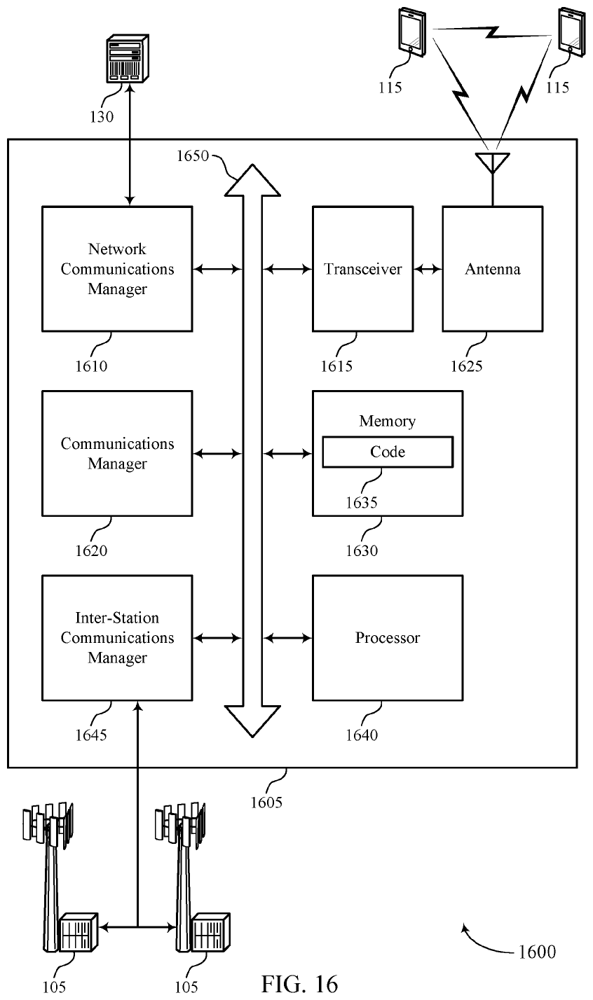

FIG. 16 shows a diagram of a system 1600 including a device 1605 that supports frequency hopping considerations for Msg3 PUSCH repetitions in accordance with aspects of the present disclosure. The device 1605 may be an example of or include the components of a device 1305, a device 1405, or a base station 105 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, a network communications manager 1610, a transceiver 1615, an antenna 1625, a memory 1630, code 1635, a processor 1640, and an inter-station communications manager 1645. These components may be in electronic communication or otherwise coupled (e.g., operatively, communicatively, functionally, electronically, electrically) via one or more buses (e.g., a bus 1650).

The network communications manager 1610 may manage communications with a core network 130 (e.g., via one or more wired backhaul links). For example, the network communications manager 1610 may manage the transfer of data communications for client devices, such as one or more UEs 115.

In some cases, the device 1605 may include a single antenna 1625. However, in some other cases the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a BIOS which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting frequency hopping considerations for Msg3 PUSCH repetitions). For example, the device 1605 or a component of the device 1605 may include a processor 1640 and memory 1630 coupled to the processor 1640, the processor 1640 and memory 1630 configured to perform various functions described herein.

The inter-station communications manager 1645 may manage communications with other base stations 105, and may include a controller or scheduler for controlling communications with UEs 115 in cooperation with other base stations 105. For example, the inter-station communications manager 1645 may coordinate scheduling for transmissions to UEs 115 for various interference mitigation techniques such as beamforming or joint transmission. In some examples, the inter-station communications manager 1645 may provide an X2 interface within an LTE/LTE-A wireless communications network technology to provide communication between base stations 105.

The communications manager 1620 may support wireless communication at a base station in accordance with examples as disclosed herein. For example, the communications manager 1620 may be configured as or otherwise support a means for receiving a random access channel preamble from a UE. The communications manager 1620 may be configured as or otherwise support a means for transmitting, to the UE and in response to the random access channel preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant. The communications manager 1620 may be configured as or otherwise support a means for receiving the repetitions of the uplink transmission using one or more frequency hops in accordance with the frequency hopping configuration.

By including or configuring the communications manager 1620 in accordance with examples as described herein, the device 1605 may support techniques for signaling and/or configuring intra-slot frequency hopping as well as inter-slot frequency hopping for RACH Msg3 transmissions via PUSCH with repetition.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of frequency hopping considerations for Msg3 PUSCH repetitions as described herein, or the processor 1640 and the memory 1630 may be otherwise configured to perform or support such operations.

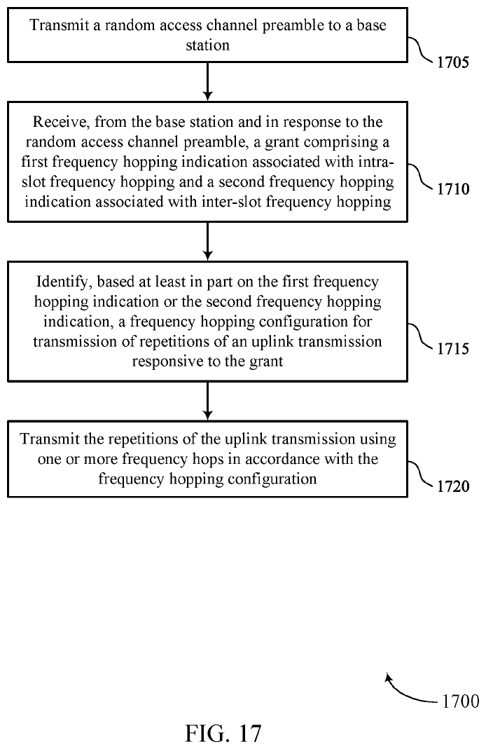

FIG. 17 shows a flowchart illustrating a method 1700 that supports frequency hopping considerations for Msg3 PUSCH repetitions in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting a random access channel preamble to a base station. The operations of 1705 may be performed in accordance with examples as disclosed herein. In some examples, aspects of the operations of 1705 may be performed by a RACH preamble manager 1125 as described with reference to FIG. 11.

At 1710, the method may include receiving, from the base station and in response to the random access channel preamble, a grant including a first frequency hopping indication associated with intra-slot frequency hopping and a second frequency hopping indication associated with inter-slot frequency hopping. The operations of 1710 may be performed in accordance with examples as disclosed herein. In some examples, aspects of the operations of 1710 may be performed by a Msg3 grant manager 1130 as described with reference to FIG. 11.

At 1715, the method may include identifying, based on the first frequency hopping indication or the second frequency hopping indication, a frequency hopping configuration for transmission of repetitions of an uplink transmission responsive to the grant. The operations of 1715 may be performed in accordance with examples as disclosed herein. In some examples, aspects of the operations of 1715 may be performed by a frequency hopping manager 1135 as described with reference to FIG. 11.

At 1720, the method may include transmitting the repetitions of the uplink transmission using one or more frequency hops in accordance with the frequency hopping configuration. The operations of 1720 may be performed in accordance with examples as disclosed herein. In some examples, aspects of the operations of 1720 may be performed by a frequency hopping manager 1135 as described with reference to FIG. 11.

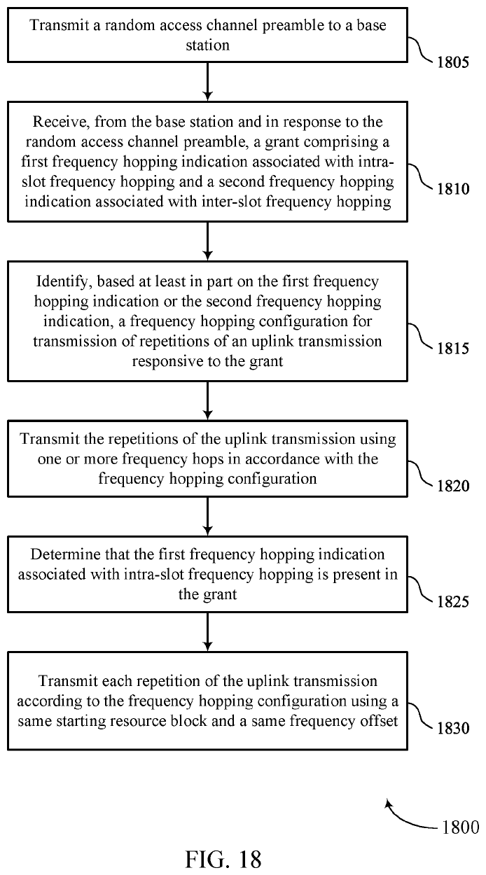

FIG. 18 shows a flowchart illustrating a method 1800 that supports frequency hopping considerations for Msg3 PUSCH repetitions in accordance with aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include transmitting a random access channel preamble to a base station. The operations of 1805 may be performed in accordance with examples as disclosed herein. In some examples, aspects of the operations of 1805 may be performed by a RACH preamble manager 1125 as described with reference to FIG. 11.

At 1810, the method may include receiving, from the base station and in response to the random access channel preamble, a grant including a first frequency hopping indication associated with intra-slot frequency hopping and a second frequency hopping indication associated with inter-slot frequency hopping. The operations of 1810 may be performed in accordance with examples as disclosed herein. In some examples, aspects of the operations of 1810 may be performed by a Msg3 grant manager 1130 as described with reference to FIG. 11.

At 1815, the method may include identifying, based on the first frequency hopping indication or the second frequency hopping indication, a frequency hopping configuration for transmission of repetitions of an uplink transmission responsive to the grant. The operations of 1815 may be performed in accordance with examples as disclosed herein. In some examples, aspects of the operations of 1815 may be performed by a frequency hopping manager 1135 as described with reference to FIG. 11.

At 1820, the method may include transmitting the repetitions of the uplink transmission using one or more frequency hops in accordance with the frequency hopping configuration. The operations of 1820 may be performed in accordance with examples as disclosed herein. In some examples, aspects of the operations of 1820 may be performed by a frequency hopping manager 1135 as described with reference to FIG. 11.

At 1825, the method may include determining that the first frequency hopping indication associated with intra-slot frequency hopping is present in the grant. The operations of 1825 may be performed in accordance with examples as disclosed herein. In some examples, aspects of the operations of 1825 may be performed by an intra-slot frequency hopping manager 1140 as described with reference to FIG. 11.

At 1830, the method may include transmitting each repetition of the uplink transmission according to the frequency hopping configuration using a same starting resource block and a same frequency offset. The operations of 1830 may be performed in accordance with examples as disclosed herein. In some examples, aspects of the operations of 1830 may be performed by an intra-slot frequency hopping manager 1140 as described with reference to FIG. 11.

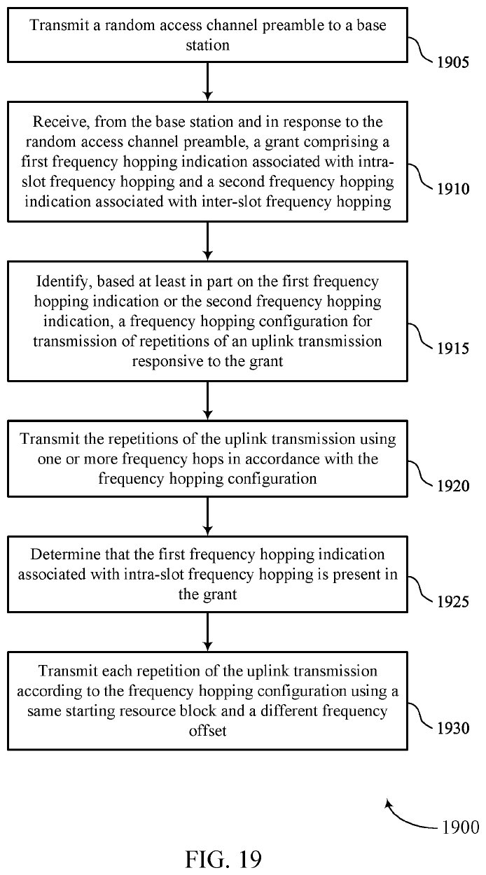

FIG. 19 shows a flowchart illustrating a method 1900 that supports frequency hopping considerations for Msg3 PUSCH repetitions in accordance with aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include transmitting a random access channel preamble to a base station. The operations of 1905 may be performed in accordance with examples as disclosed herein. In some examples, aspects of the operations of 1905 may be performed by a RACH preamble manager 1125 as described with reference to FIG. 11.

At 1910, the method may include receiving, from the base station and in response to the random access channel preamble, a grant including a first frequency hopping indication associated with intra-slot frequency hopping and a second frequency hopping indication associated with inter-slot frequency hopping. The operations of 1910 may be performed in accordance with examples as disclosed herein. In some examples, aspects of the operations of 1910 may be performed by a Msg3 grant manager 1130 as described with reference to FIG. 11.

At 1915, the method may include identifying, based on the first frequency hopping indication or the second frequency hopping indication, a frequency hopping configuration for transmission of repetitions of an uplink transmission responsive to the grant. The operations of 1915 may be performed in accordance with examples as disclosed herein. In some examples, aspects of the operations of 1915 may be performed by a frequency hopping manager 1135 as described with reference to FIG. 11.

At 1920, the method may include transmitting the repetitions of the uplink transmission using one or more frequency hops in accordance with the frequency hopping configuration. The operations of 1920 may be performed in accordance with examples as disclosed herein. In some examples, aspects of the operations of 1920 may be performed by a frequency hopping manager 1135 as described with reference to FIG. 11.

At 1925, the method may include determining that the first frequency hopping indication associated with intra-slot frequency hopping is present in the grant. The operations of 1925 may be performed in accordance with examples as disclosed herein. In some examples, aspects of the operations of 1925 may be performed by an intra-slot frequency hopping manager 1140 as described with reference to FIG. 11.

At 1930, the method may include transmitting each repetition of the uplink transmission according to the frequency hopping configuration using a same starting resource block and a different frequency offset. The operations of 1930 may be performed in accordance with examples as disclosed herein. In some examples, aspects of the operations of 1930 may be performed by an intra-slot frequency hopping manager 1140 as described with reference to FIG. 11.

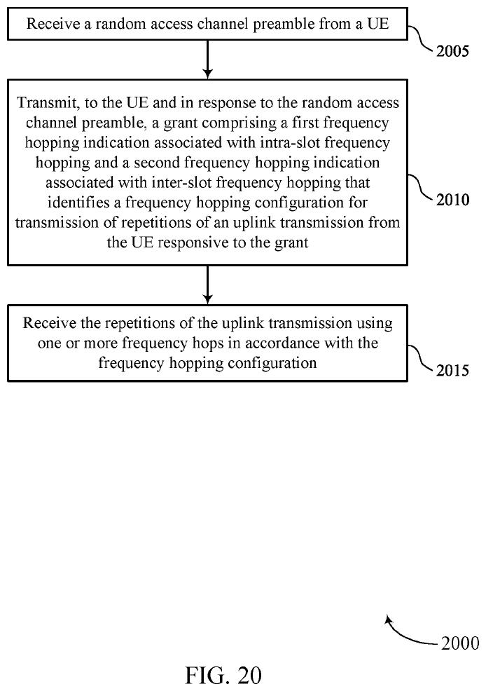

FIG. 20 shows a flowchart illustrating a method 2000 that supports frequency hopping considerations for Msg3 PUSCH repetitions in accordance with aspects of the present disclosure. The operations of the method 2000 may be implemented by a base station or its components as described herein. For example, the operations of the method 2000 may be performed by a base station 105 as described with reference to FIGS. 1 through 7 and 13 through 16. In some examples, a base station may execute a set of instructions to control the functional elements of the base station to perform the described functions. Additionally, or alternatively, the base station may perform aspects of the described functions using special-purpose hardware.

At 2005, the method may include receiving a random access channel preamble from a UE. The operations of 2005 may be performed in accordance with examples as disclosed herein. In some examples, aspects of the operations of 2005 may be performed by a RACH preamble manager 1525 as described with reference to FIG. 15.

At 2010, the method may include transmitting, to the UE and in response to the random access channel preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant. The operations of 2010 may be performed in accordance with examples as disclosed herein. In some examples, aspects of the operations of 2010 may be performed by a Msg3 grant manager 1530 as described with reference to FIG. 15.

At 2015, the method may include receiving the repetitions of the uplink transmission using one or more frequency hops in accordance with the frequency hopping configuration. The operations of 2015 may be performed in accordance with examples as disclosed herein. In some examples, aspects of the operations of 2015 may be performed by a frequency hopping manager 1535 as described with reference to FIG. 15.

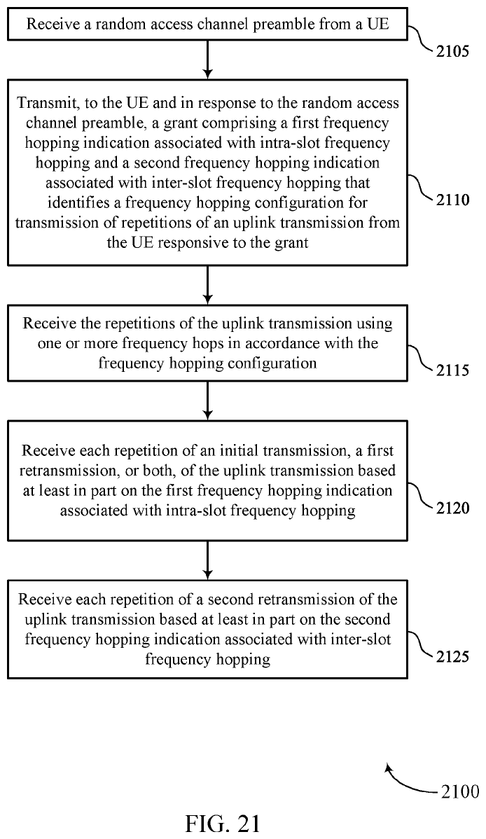

FIG. 21 shows a flowchart illustrating a method 2100 that supports frequency hopping considerations for Msg3 PUSCH repetitions in accordance with aspects of the present disclosure. The operations of the method 2100 may be implemented by a base station or its components as described herein. For example, the operations of the method 2100 may be performed by a base station 105 as described with reference to FIGS. 1 through 7 and 13 through 16. In some examples, a base station may execute a set of instructions to control the functional elements of the base station to perform the described functions. Additionally, or alternatively, the base station may perform aspects of the described functions using special-purpose hardware.

At 2105, the method may include receiving a random access channel preamble from a UE. The operations of 2105 may be performed in accordance with examples as disclosed herein. In some examples, aspects of the operations of 2105 may be performed by a RACH preamble manager 1525 as described with reference to FIG. 15.

At 2110, the method may include transmitting, to the UE and in response to the random access channel preamble, a grant including a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant. The operations of 2110 may be performed in accordance with examples as disclosed herein. In some examples, aspects of the operations of 2110 may be performed by a Msg3 grant manager 1530 as described with reference to FIG. 15.

At 2115, the method may include receiving the repetitions of the uplink transmission using one or more frequency hops in accordance with the frequency hopping configuration. The operations of 2115 may be performed in accordance with examples as disclosed herein. In some examples, aspects of the operations of 2115 may be performed by a frequency hopping manager 1535 as described with reference to FIG. 15.

At 2120, the method may include receiving each repetition of an initial transmission, a first retransmission, or both, of the uplink transmission based on the first frequency hopping indication associated with intra-slot frequency hopping. The operations of 2120 may be performed in accordance with examples as disclosed herein. In some examples, aspects of the operations of 2120 may be performed by a repetition manager 1555 as described with reference to FIG. 15.

At 2125, the method may include receiving each repetition of a second retransmission of the uplink transmission based on the second frequency hopping indication associated with inter-slot frequency hopping. The operations of 2125 may be performed in accordance with examples as disclosed herein. In some examples, aspects of the operations of 2125 may be performed by a repetition manager 1555 as described with reference to FIG. 15.

The following provides an overview of aspects of the present disclosure:

Aspect 1: A method for wireless communication at a UE, comprising: transmitting a RACH preamble to a base station; receiving, from the base station and in response to the RACH preamble, a grant comprising a first frequency hopping indication associated with intra-slot frequency hopping and a second frequency hopping indication associated with inter-slot frequency hopping; identifying, based at least in part on the first frequency hopping indication or the second frequency hopping indication, a frequency hopping configuration for transmission of repetitions of an uplink transmission responsive to the grant; and transmitting the repetitions of the uplink transmission using one or more frequency hops in accordance with the frequency hopping configuration.

Aspect 2: The method of aspect 1, further comprising: determining that the first frequency hopping indication associated with intra-slot frequency hopping is configured in the grant; and transmitting each repetition of the uplink transmission according to the frequency hopping configuration using a same starting resource block and a same frequency offset within a slot.

Aspect 3: The method of any of aspects 1 through 2, further comprising: determining that the first frequency hopping indication associated with intra-slot frequency hopping is configured in the grant; and transmitting each repetition of the uplink transmission according to the frequency hopping configuration using a same starting resource block and a different frequency offset within a slot.

Aspect 4: The method of any of aspects 1 through 3, wherein receiving the grant comprises: receiving a RAR message.

Aspect 5: The method of any of aspects 1 through 4, wherein receiving the grant comprises: receiving a DCI message that includes a CRC scrambled by either a random access radio network temporary identifier or a temporary cell random access radio network temporary identifier, wherein the second frequency hopping indication is included within reserved bits of the DCI message.

Aspect 6: The method of aspect 5, wherein the reserved bits include bits reserved for at least one of a HARQ process number or a NDI.

Aspect 7: The method of any of aspects 1 through 6, wherein either the first frequency hopping indication or the second frequency hopping indication are configured for the uplink transmission by the grant.

Aspect 8: The method of any of aspects 1 through 7, further comprising: transmitting each repetition of an initial transmission, a first retransmission, or both, of the uplink transmission based at least in part on the first frequency hopping indication associated with intra-slot frequency hopping; and transmitting each repetition of a second retransmission of the uplink transmission based at least in part on the second frequency hopping indication associated with inter-slot frequency hopping.

Aspect 9: The method of any of aspects 1 through 8, further comprising: transmitting each repetition of an initial transmission, a first retransmission, or both, of the uplink transmission based at least in part on the second frequency hopping indication associated with inter-slot frequency hopping; and transmitting each repetition of a second retransmission of the uplink transmission based at least in part on the first frequency hopping indication associated with intra-slot frequency hopping.

Aspect 10: The method of any of aspects 1 through 9, further comprising: determining that both the first frequency hopping indication associated with intra-slot frequency hopping and that the second frequency hopping indication associated with inter-slot frequency hopping are configured in the grant; and selecting the frequency hopping configuration based on the first frequency hopping indication.

Aspect 11: The method of any of aspects 1 through 10, further comprising: determining that both the first frequency hopping indication associated with intra-slot frequency hopping and that the second frequency hopping indication associated with inter-slot frequency hopping are configured in the grant; and selecting the frequency hopping configuration based on the second frequency hopping indication.

Aspect 12: A method for wireless communication at a base station, comprising: receiving a RACH preamble from a UE; transmitting, to the UE and in response to the RACH preamble, a grant comprising a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant; and receiving the repetitions of the uplink transmission using one or more frequency hops in accordance with the frequency hopping configuration.

Aspect 13: The method of aspect 12, wherein the first frequency hopping indication associated with intra-slot frequency hopping is configured in the grant, further comprising: receiving each repetition of the uplink transmission according to the frequency hopping configuration using a same starting resource block and a same frequency offset within a slot.

Aspect 14: The method of any of aspects 12 through 13, wherein the first frequency hopping indication associated with intra-slot frequency hopping is configured in the grant, further comprising: receiving each repetition of the uplink transmission according to the frequency hopping configuration using a same starting resource block and a different frequency offset within a slot.

Aspect 15: The method of any of aspects 12 through 14, wherein transmitting the grant comprises: transmitting a RAR message.

Aspect 16: The method of any of aspects 12 through 15, wherein transmitting the grant comprises: transmitting a DCI message that includes a CRC scrambled by either a random access radio network temporary identifier or a temporary cell random access network temporary identifier, wherein the second frequency hopping indication is included within reserved bits of the DCI message.

Aspect 17: The method of aspect 16, wherein the reserved bits include bits reserved for at least one of a HARQ process number or a NDI.

Aspect 18: The method of any of aspects 12 through 17, wherein either the first frequency hopping indication or the second frequency hopping indication are configured for the uplink transmission by the grant.

Aspect 19: The method of any of aspects 12 through 18, further comprising: receiving each repetition of an initial transmission, a first retransmission, or both, of the uplink transmission based at least in part on the first frequency hopping indication associated with intra-slot frequency hopping; and receiving each repetition of a second retransmission of the uplink transmission based at least in part on the second frequency hopping indication associated with inter-slot frequency hopping.

Aspect 20: The method of any of aspects 12 through 19, further comprising: receiving each repetition of an initial transmission, a first retransmission, or both, of the uplink transmission based at least in part on the second frequency hopping indication associated with inter-slot frequency hopping; and receiving each repetition of a second retransmission of the uplink transmission based at least in part on the first frequency hopping indication associated with intra-slot frequency hopping.

Aspect 21: An apparatus for wireless communication at a UE, comprising a processor; memory coupled with the processor; and instructions stored in the memory and executable by the processor to cause the apparatus to perform a method of any of aspects 1 through 11.

Aspect 22: An apparatus for wireless communication at a UE, comprising at least one means for performing a method of any of aspects 1 through 11.

Aspect 23: A non-transitory computer-readable medium storing code for wireless communication at a UE, the code comprising instructions executable by a processor to perform a method of any of aspects 1 through 11.

Aspect 24: An apparatus for wireless communication at a base station, comprising a processor; memory coupled with the processor; and instructions stored in the memory and executable by the processor to cause the apparatus to perform a method of any of aspects 12 through 20.

Aspect 25: An apparatus for wireless communication at a base station, comprising at least one means for performing a method of any of aspects 12 through 20.

Aspect 26: A non-transitory computer-readable medium storing code for wireless communication at a base station, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
transmitting a random access channel preamble to a base station;
receiving, from the base station and in response to the random access channel preamble, a grant comprising a first frequency hopping indication associated with intra-slot frequency hopping and a second frequency hopping indication associated with inter-slot frequency hopping;
identifying, based at least in part on the first frequency hopping indication or the second frequency hopping indication, a frequency hopping configuration for transmission of repetitions of an uplink transmission responsive to the grant; and
transmitting the repetitions of the uplink transmission using one or more frequency hops in accordance with the frequency hopping configuration.

2. The method of claim 1, further comprising:
determining that the first frequency hopping indication associated with intra-slot frequency hopping is present in the grant; and
transmitting each repetition of the uplink transmission according to the frequency hopping configuration using a same starting resource block and a same frequency offset.

3. The method of claim 1, further comprising:
determining that the first frequency hopping indication associated with intra-slot frequency hopping is present in the grant; and
transmitting each repetition of the uplink transmission according to the frequency hopping configuration using a same starting resource block and a different frequency offset.

4. The method of claim 1, wherein receiving the grant comprises:
receiving a random access response message.

5. The method of claim 1, wherein receiving the grant comprises:
receiving a downlink control information message that includes a cyclic redundancy check scrambled by either a random access radio network temporary identifier or a temporary cell random access radio network temporary identifier, wherein the second frequency hopping indication is included within reserved bits of the downlink control information message.

6. The method of claim 5, wherein the reserved bits include bits reserved for at least one of a hybrid automatic repeat request process number or a new data indicator.

7. The method of claim 1, wherein either the first frequency hopping indication or the second frequency hopping indication is configured for the uplink transmission by the grant.

8. The method of claim 1, further comprising:
transmitting each repetition of an initial transmission, a first retransmission, or both, of the uplink transmission based at least in part on the first frequency hopping indication associated with intra-slot frequency hopping; and
transmitting each repetition of a second retransmission of the uplink transmission based at least in part on the second frequency hopping indication associated with inter-slot frequency hopping.

9. The method of claim 1, further comprising:
transmitting each repetition of an initial transmission, a first retransmission, or both, of the uplink transmission based at least in part on the second frequency hopping indication associated with inter-slot frequency hopping; and
transmitting each repetition of a second retransmission of the uplink transmission based at least in part on the first frequency hopping indication associated with intra-slot frequency hopping.

10. The method of claim 1, further comprising:
determining that both the first frequency hopping indication associated with intra-slot frequency hopping and that the second frequency hopping indication associated with inter-slot frequency hopping are enabled in the grant; and
selecting the frequency hopping configuration based on the first frequency hopping indication.

11. The method of claim 1, further comprising:
determining that both the first frequency hopping indication associated with intra-slot frequency hopping and that the second frequency hopping indication associated with inter-slot frequency hopping are enabled in the grant; and
selecting the frequency hopping configuration based on the second frequency hopping indication.

12. A method for wireless communication at a base station, comprising:
receiving a random access channel preamble from a user equipment (UE);
transmitting, to the UE and in response to the random access channel preamble, a grant comprising a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant; and
receiving the repetitions of the uplink transmission using one or more frequency hops in accordance with the frequency hopping configuration.

13. The method of claim 12, wherein the first frequency hopping indication associated with intra-slot frequency hopping is enabled in the grant, further comprising:
receiving each repetition of the uplink transmission according to the frequency hopping configuration using a same starting resource block and a same frequency offset.

14. The method of claim 12, wherein the first frequency hopping indication associated with intra-slot frequency hopping is enabled in the grant, further comprising:
receiving each repetition of the uplink transmission according to the frequency hopping configuration using a same starting resource block and a different frequency offset.

15. The method of claim 12, wherein transmitting the grant comprises:
transmitting a random access response message.

16. The method of claim 12, wherein transmitting the grant comprises:
transmitting a downlink control information message that includes a cyclic redundancy check scrambled by either a random access radio network temporary identifier or a temporary cell random access network temporary identifier, wherein the second frequency hopping indication is included within reserved bits of the downlink control information message.

17. The method of claim 16, wherein the reserved bits include bits reserved for at least one of a hybrid automatic repeat request process number or a new data indicator.

18. The method of claim 12, wherein either the first frequency hopping indication or the second frequency hopping indication is configured for the uplink transmission by the grant.

19. The method of claim 12, further comprising:
receiving each repetition of an initial transmission, a first retransmission, or both, of the uplink transmission based at least in part on the first frequency hopping indication associated with intra-slot frequency hopping; and
receiving each repetition of a second retransmission of the uplink transmission based at least in part on the second frequency hopping indication associated with inter-slot frequency hopping.

20. The method of claim 12, further comprising:
receiving each repetition of an initial transmission, a first retransmission, or both, of the uplink transmission based at least in part on the second frequency hopping indication associated with inter-slot frequency hopping; and
receiving each repetition of a second retransmission of the uplink transmission based at least in part on the first frequency hopping indication associated with intra-slot frequency hopping.

21. An apparatus for wireless communication at a user equipment (UE), comprising:
a processor;
memory coupled with the processor; and
instructions stored in the memory and executable by the processor to cause the apparatus to:
transmit a random access channel preamble to a base station;
receive, from the base station and in response to the random access channel preamble, a grant comprising a first frequency hopping indication associated with intra-slot frequency hopping and a second frequency hopping indication associated with inter-slot frequency hopping;
identify, based at least in part on the first frequency hopping indication or the second frequency hopping indication, a frequency hopping configuration for transmission of repetitions of an uplink transmission responsive to the grant; and
transmit the repetitions of the uplink transmission using one or more frequency hops in accordance with the frequency hopping configuration.

22. The apparatus of claim 21, wherein the instructions are further executable by the processor to cause the apparatus to:
determine that the first frequency hopping indication associated with intra-slot frequency hopping is present in the grant; and
transmit each repetition of the uplink transmission according to the frequency hopping configuration using a same starting resource block and a same frequency offset.

23. The apparatus of claim 21, wherein the instructions are further executable by the processor to cause the apparatus to:
determine that the first frequency hopping indication associated with intra-slot frequency hopping is present in the grant; and
transmit each repetition of the uplink transmission according to the frequency hopping configuration using a same starting resource block and a different frequency offset.

24. The apparatus of claim 21, wherein the instructions to receive the grant are executable by the processor to cause the apparatus to:
receive a random access response message.

25. The apparatus of claim 21, wherein the instructions to receive the grant are executable by the processor to cause the apparatus to:
receive a downlink control information message that includes a cyclic redundancy check scrambled by either a random access radio network temporary identifier or a temporary cell random access radio network temporary identifier, wherein the second frequency hopping indication is included within reserved bits of the downlink control information message.

26. The apparatus of claim 25, wherein the reserved bits include bits reserved for at least one of a hybrid automatic repeat request process number or a new data indicator.

27. The apparatus of claim 21, wherein either the first frequency hopping indication or the second frequency hopping indication is configured for the uplink transmission by the grant.

28. The apparatus of claim 21, wherein the instructions are further executable by the processor to cause the apparatus to:
transmit each repetition of an initial transmission, a first retransmission, or both, of the uplink transmission based at least in part on the first frequency hopping indication associated with intra-slot frequency hopping; and
transmit each repetition of a second retransmission of the uplink transmission based at least in part on the second frequency hopping indication associated with inter-slot frequency hopping.

29. The apparatus of claim 21, wherein the instructions are further executable by the processor to cause the apparatus to:
transmit each repetition of an initial transmission, a first retransmission, or both, of the uplink transmission based at least in part on the second frequency hopping indication associated with inter-slot frequency hopping; and
transmit each repetition of a second retransmission of the uplink transmission based at least in part on the first frequency hopping indication associated with intra-slot frequency hopping.

30. The apparatus of claim 21, wherein the instructions are further executable by the processor to cause the apparatus to:
determine that both the first frequency hopping indication associated with intra-slot frequency hopping and that the second frequency hopping indication associated with inter-slot frequency hopping are enabled in the grant; and
select the frequency hopping configuration based on the first frequency hopping indication.

31. The apparatus of claim 21, wherein the instructions are further executable by the processor to cause the apparatus to:
determine that both the first frequency hopping indication associated with intra-slot frequency hopping and that the second frequency hopping indication associated with inter-slot frequency hopping are enabled in the grant; and
select the frequency hopping configuration based on the second frequency hopping indication.

32. An apparatus for wireless communication at a base station, comprising:
a processor;
memory coupled with the processor; and
instructions stored in the memory and executable by the processor to cause the apparatus to:
receive a random access channel preamble from a user equipment (UE);
transmit, to the UE and in response to the random access channel preamble, a grant comprising a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant; and
receive the repetitions of the uplink transmission using one or more frequency hops in accordance with the frequency hopping configuration.

33. The apparatus of claim 32, wherein the first frequency hopping indication associated with intra-slot frequency hopping is enabled in the grant, and wherein the instructions are further executable by the processor to cause the apparatus to:
receive each repetition of the uplink transmission according to the frequency hopping configuration using a same starting resource block and a same frequency offset.

34. The apparatus of claim 32, wherein the first frequency hopping indication associated with intra-slot frequency hopping is enabled in the grant, and wherein the instructions are further executable by the processor to cause the apparatus to:
receive each repetition of the uplink transmission according to the frequency hopping configuration using a same starting resource block and a different frequency offset.

35. The apparatus of claim 32, wherein the instructions to transmit the grant are executable by the processor to cause the apparatus to:
transmit a random access response message.

36. The apparatus of claim 32, wherein the instructions to transmit the grant are executable by the processor to cause the apparatus to:
transmit a downlink control information message that includes a cyclic redundancy check scrambled by either a random access radio network temporary identifier or a temporary cell random access network temporary identifier, wherein the second frequency hopping indication is included within reserved bits of the downlink control information message.

37. The apparatus of claim 36, wherein the reserved bits include bits reserved for at least one of a hybrid automatic repeat request process number or a new data indicator.

38. The apparatus of claim 32, wherein either the first frequency hopping indication or the second frequency hopping indication is configured for the uplink transmission by the grant.

39. The apparatus of claim 32, wherein the instructions are further executable by the processor to cause the apparatus to:
receive each repetition of an initial transmission, a first retransmission, or both, of the uplink transmission based at least in part on the first frequency hopping indication associated with intra-slot frequency hopping; and
receive each repetition of a second retransmission of the uplink transmission based at least in part on the second frequency hopping indication associated with inter-slot frequency hopping.

40. The apparatus of claim 32, wherein the instructions are further executable by the processor to cause the apparatus to:
receive each repetition of an initial transmission, a first retransmission, or both, of the uplink transmission based at least in part on the second frequency hopping indication associated with inter-slot frequency hopping; and
receive each repetition of a second retransmission of the uplink transmission based at least in part on the first frequency hopping indication associated with intra-slot frequency hopping.

41. An apparatus for wireless communication at a user equipment (UE), comprising:
means for transmitting a random access channel preamble to a base station;
means for receiving, from the base station and in response to the random access channel preamble, a grant comprising a first frequency hopping indication associated with intra-slot frequency hopping and a second frequency hopping indication associated with inter-slot frequency hopping;
means for identifying, based at least in part on the first frequency hopping indication or the second frequency hopping indication, a frequency hopping configuration for transmission of repetitions of an uplink transmission responsive to the grant; and
means for transmitting the repetitions of the uplink transmission using one or more frequency hops in accordance with the frequency hopping configuration.

42. An apparatus for wireless communication at a base station, comprising:
means for receiving a random access channel preamble from a user equipment (UE);
means for transmitting, to the UE and in response to the random access channel preamble, a grant comprising a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant; and
means for receiving the repetitions of the uplink transmission using one or more frequency hops in accordance with the frequency hopping configuration.

43. A non-transitory computer-readable medium storing code for wireless communication at a user equipment (UE), the code comprising instructions executable by a processor to:
transmit a random access channel preamble to a base station;
receive, from the base station and in response to the random access channel preamble, a grant comprising a first frequency hopping indication associated with intra-slot frequency hopping and a second frequency hopping indication associated with inter-slot frequency hopping;
identify, based at least in part on the first frequency hopping indication or the second frequency hopping indication, a frequency hopping configuration for transmission of repetitions of an uplink transmission responsive to the grant; and
transmit the repetitions of the uplink transmission using one or more frequency hops in accordance with the frequency hopping configuration.

44. A non-transitory computer-readable medium storing code for wireless communication at a base station, the code comprising instructions executable by a processor to:
receive a random access channel preamble from a user equipment (UE);
transmit, to the UE and in response to the random access channel preamble, a grant comprising a first frequency hopping indication associated with intra-slot frequency hopping and a second frequency hopping indication associated with inter-slot frequency hopping that identifies a frequency hopping configuration for transmission of repetitions of an uplink transmission from the UE responsive to the grant; and
receive the repetitions of the uplink transmission using one or more frequency hops in accordance with the frequency hopping configuration.

45-66. (canceled)
